(19) United States
(12) Patent Application Publication
(10) Pub. No.: US 2022/0258141 A1
(43) Pub. Date: Aug. 18, 2022

(54) SELECTIVE CATALYTIC REDUCTION CATALYST COMPRISING COPPER CARBONATE

(71) Applicant: BASF CORPORATION, FLORHAM PARK, NJ (US)

(72) Inventors: Yi Liu, Livingston, AL (US); Brian T. Jones, Huntsville, AL (US); Donald H. Reeder, Huntsville, AL (US); Eric George Klauber, Huntsville, AL (US); Oliver Seel, Nienburg (DE); Torsten Neubauer, Langenhagen (DE); Saeed Alerasool, Pudong (CN); James Dale Hoggard, Harvest, AL (US); John Robert White, Madison, AL (US); Claudia Zabel, Hannover (DE)

(73) Assignee: BASF CORPORATION, FLORHAM PARK, NJ (US)

(21) Appl. No.: 17/608,184

(22) PCT Filed: May 6, 2020
(86) PCT No.: PCT/US20/31554

§ 371 Date: Nov. 2, 2021

Related U.S. Application Data
(60) Provisional application No. 62/845,366, filed on May 9, 2019.

(51) Int. Cl. B01J 29/76; B01J 37/00; B01J 37/04; B01J 35/02; B01J 35/10; B01J 37/03; B01J 37/08; B01J 37/30; B01J 35/04; F01N 3/20; F01N 3/28; B01D 53/94

(52) U.S. Cl. CPC B01J 29/763; B01D 2255/9155; B01J 37/04; B01J 35/023; B01J 35/1019; B01J 35/1023; B01J 35/1028; B01J 37/038; B01J 37/082; B01J 37/30; B01J 35/04; F01N 3/2066; F01N 3/2803; F01N 3/2842; B01D 53/9418; F01N 2370/04; B01D 2255/50; B01D 2255/20761; B01D 2255/9207; B01J 37/0009

(57) ABSTRACT

The present disclosure provides catalyst compositions capable of reducing nitrogen oxide (NOₓ) emissions in engine exhaust, catalyst articles coated with such compositions, and processes for preparing such catalyst compositions and articles. The catalyst compositions include metal ion-exchanged zeolites useful for selective catalytic reduction (SCR) of NOₓ. Further provided is an exhaust gas treatment system including such catalytic articles, and methods for reducing NOₓ in an exhaust gas stream using such catalytic articles.

### CROSS-REFERENCE TO RELATED APPLICATIONS

This application claims the benefit of priority to U.S. Provisional Application No. 62/845,366, filed May 9, 2019 in its entirety.

### FIELD OF THE DISCLOSURE

The present disclosure relates generally to the field of exhaust gas treatment catalysts, particularly catalyst compositions capable of selectively reducing nitrogen oxides in engine exhaust, catalyst articles coated with such compositions, and processes for preparing such catalyst compositions. More particularly are provided improved metal promoted zeolites that can be useful as Selective Catalytic Reduction (SCR) catalysts, and processes for their preparation.

### BACKGROUND

Over time, the harmful components of nitrogen oxides (NOₓ) have led to atmospheric pollution. NOₓ is contained in exhaust gases, such as from internal combustion engines (e.g., in automobiles and trucks), from combustion installations (e.g., power stations heated by natural gas, oil, or coal), and from nitric acid production plants.

Various treatment methods have been used for the treatment of NOₓ-containing gas mixtures to decrease atmospheric pollution. One type of treatment involves catalytic reduction of nitrogen oxides. There are two processes: (1) a nonselective reduction process wherein carbon monoxide, hydrogen, or a lower molecular weight hydrocarbon is used as a reducing agent; and (2) a selective reduction process wherein ammonia or an ammonia precursor is used as a reducing agent. In the selective reduction process, a high degree of nitrogen oxide removal can be achieved with a stoichiometric amount of reducing agent.

The selective reduction process is referred to as a SCR (Selective Catalytic Reduction) process. The SCR process uses catalytic reduction of nitrogen oxides with a reductant (e.g., ammonia) in the presence of atmospheric oxygen, resulting in the formation predominantly of nitrogen and steam:
4NO+4NH₃+O₂→4N₂+6H₂O (standard SCR reaction)
2NO₂+4NH₃+O₂→3N₂+6H₂O (slow SCR reaction)
NO+NO₂+2NH₃→2N₂+3H₂O (fast SCR reaction)

Catalysts employed in the SCR process ideally should be able to retain good catalytic activity over a wide range of temperature conditions of use, for example, 200° C. to 600° C. or higher, under hydrothermal conditions. SCR catalysts are commonly employed in hydrothermal conditions, such as during the regeneration of a soot filter, a component of the exhaust gas treatment system used for the removal of particles.

Current catalysts employed in the SCR process include metal-promoted zeolites, which have been used in SCR of nitrogen oxides with a reductant such as ammonia, urea, or a hydrocarbon in the presence of oxygen. Metal-promoted zeolite SCR catalysts including, among others, iron-promoted and copper-promoted zeolite catalysts, are known. For example, iron-promoted zeolite beta has been an effective commercial catalyst for the selective reduction of nitrogen oxides with ammonia. Unfortunately, it has been found that under harsh hydrothermal conditions (e.g., as exhibited during the regeneration of a soot filter with temperatures locally exceeding 700° C.), the activity of many metal-promoted zeolites begins to decline. This decline has been attributed to dealumination of the zeolite and the consequent loss of metal-containing active centers within the zeolite.

Metal-promoted, particularly copper-promoted, aluminosilicate zeolites having the CHA structure type have solicited a high degree of interest as catalysts for the SCR of oxides of nitrogen in lean burning engines using nitrogenous reductants. These materials exhibit activity within a wide temperature window and excellent hydrothermal durability, as described in U.S. Pat. No. 7,601,662.

Although the catalysts described in U.S. Pat. No.7,601,662 exhibit excellent properties, rendering them useful e.g., in the context of SCR catalysis, there is a continued desire for SCR catalysts with improved performance over extended and/or different temperature windows. One of the challenges of meeting current governmental NOₓ regulations is to provide metal-promoted, zeolite-based SCR catalysts with improved low temperature performance. Accordingly, there remains a need to provide further improved processes for preparing metal promoted zeolitic SCR and Selective Catalytic Reduction on Filter (SCRoF) catalysts with improved low and high temperature performance relative to currently available metal promoted zeolitic SCR and SCRoF catalysts.

### SUMMARY OF THE DISCLOSURE

The present disclosure generally relates to a process for preparing advanced selective catalytic reduction (SCR) catalysts and selective catalytic reduction on filter (SCRoF) catalysts, and articles comprising the SCR or SCRoF catalysts prepared according to the disclosed process. Surprisingly, it was found that the process of the present disclosure provides SCR and SCRoF catalysts achieving high catalytic activities, such as significantly increased NOₓ conversion relative at any temperature, and especially at low temperature, relative to standard Cu-chabazite reference SCR catalysts.

Accordingly, in one aspect is provided a process for preparing a SCR catalyst or a SCRoF catalyst, said SCR or SCRoF catalyst comprising a metal ion-exchanged zeolite, the process comprising: (i) admixing a zeolite with an aqueous mixture comprising water and a metal ion source comprising a carbonate salt of copper, iron, or a mixture thereof, to form a slurry comprising a treated zeolite.

In some embodiments, the process further comprises adding a binder during the admixing step.

In some embodiments, the process further comprises milling the aqueous mixture prior to performing the admixing step. In some embodiments, the aqueous mixture comprises particles of the metal ion source having a D90 value of from about 0.5 to about 20 micrometers. In some embodiments, the aqueous mixture comprises particles of the metal ion source having a D50 value of from about 1 to about 3 micrometers, and D90 value of from about 4 to about 10 micrometers. In some embodiments, the aqueous mixture further comprises one or more additives selected from one or more of a sugar, a dispersing agent, a surface tension reducer, a rheology modifier, or a combination thereof.

In some embodiments, the zeolite has a framework type selected from the group consisting of ABW, ACO, AEI, AEL, AEN, AET, AFG, AFI, AFN, AFO, AFR, AFS, AFT, AFV, AFX, AFY, AHT, ANA, APC, APD, AST, ASV, ATN, ATO, ATS, ATT, ATV, AVL, AWO, AWW, BCT, BEA, BEC, BIK, BOF, BOG, BOZ, BPH, BRE, BSV, CAN, CAS, CDO, CFI, CGF, CGS, CHA, CHI, CLO, CON, CSV, CZP, DAC, DDR, DFO, DFT, DOH, DON, EAB, EDI, EEI, EMT, EON, EPI, ERI, ESV, ETR, EUO, EWT, EZT, FAU, FER, FRA, GIS, GIU, GME, GON, GOO, HEU, IFO, IFR, IFU, IFW, IFY, IHW, IMF, IRN, IRR, IRY, ISV, ITE, ITG, ITH, ITN, ITR, ITT, ITV, ITW, IWR, IWS, IWV, IWW, JBW, JNT, JOZ, JRY, JSN, JSR, JST, JSW, KFI, LAU, LEV, LIO, LIT, LOS, LOV, LTA, LTF, LTJ, LTL, LTN, MAR, MAZ, MEI, MEL, MEP, MER, MFI, MFS, MON, MOR, MOZ, MRE, MSE, MSO, MTF, MTN, MTT, MTW, MVY, MWF, MWW, NAB, NAT, NES, NON, NPO, NPT, NSI, OBW, OFF, OKO, OSI, OSO, OWE, PAR, PAU, PCR, PHI, PON, POS, PSI, PUN, RHO, RON, RRO, RSN, RTE, RTH, RUT, RWR, RWY, SAF, SAO, SAS, SAT, SAV, SBE, SBN, SBS, SBT, SEW, SFE, SFF, SFG, SFH, SFN, SFO, SFS, SFV, SFW, SGT, SIV, SOD, SOF, SOS, SSF, SSO, SSY, STF, STI, STO, STT, STW, SVR, SVV, SZR, TER, THO, TOL, TON, TSC, TUN, UEI, UFI, UOS, UOV, UOZ, USI, UTL, UWY, VET, VFI, VNI, VSV, WEI, WEN, YUG, ZON, and mixtures or intergrowths thereof. In some embodiments, the zeolite has a framework type selected from the group consisting of CHA and AEI. In some embodiments, the zeolite has a CHA framework type.

In some embodiments, the zeolite has a framework consisting of Si, Al, and O, wherein the molar ratio of Si to Al in the framework, calculated as a molar ratio of SiO₂:Al₂O₃, is from about 2:1 to 50:1. In some embodiments, the molar ratio of SiO₂:Al₂O₃, is about 25:1.

In some embodiments, the zeolite, prior to admixing with the aqueous mixture, comprises from about 0 wt % to about 1.25 wt % of copper, calculated as CuO based on the weight of the zeolite. In some embodiments, the zeolite, prior to admixing with the first aqueous mixture, is in the NH₄⁺ form

In some embodiments, the zeolite comprises particles having a D50 value of from about 1 to about 5 micrometers, and a D90 value of from about 4 to about 10 micrometers. In some embodiments, the zeolite has a BET specific surface area of from about 200 to about 1500 m²/g.

In some embodiments, the binder comprises an oxide of Al, Si, Ti, Zr, Ce, or a mixture of two or more thereof. In some embodiments, the binder comprises alumina, silica, zirconia, a mixture thereof, or a mixed oxide comprising Al, Si, and optionally Zr. In some embodiments, the binder has a BET specific surface area from about 200 to about 1500 m²/g. In some embodiments, the binder has a D90 of from about 0.5 to about 20 micrometers. In some embodiments, the binder has a D90 of from about 4 to about 8 micrometers.

In some embodiments, the particles of the treated zeolite have a D90 value of from about 0.5 to about 20 micrometers. In some embodiments, the slurry has a solid content of from about 15 to about 45 wt %, based on the weight of said mixture

In some embodiments, the amount of metal comprised in the treated zeolite is in the range of from about 2 to about 10 wt %, about 2.5 to about 5.5 wt %, about 3 to about 5 wt %, or about 3.5 to about 4 wt %, based on the weight of the metal ion-exchanged zeolite and calculated as the metal oxide.

In some embodiments, the metal ion source is basic copper carbonate. In some embodiments, the metal ion source is iron carbonate. In some embodiments, the metal ion source further comprises one or more of copper oxide, copper hydroxide, copper nitrate, copper chloride, copper acetate, copper acetylacetonate, copper oxalate, or copper sulfate.

In some embodiments, the process further comprises:
(ii) optionally, milling the slurry comprising the treated zeolite;
(iii) contacting a substrate with the slurry comprising the treated zeolite to form a coating on the substrate, the substrate comprising an inlet end, an outlet end, an axial length extending from the inlet end to the outlet end, and a plurality of passages defined by internal walls of the substrate extending therethrough;
(iv) drying the substrate comprising the slurry disposed thereon;
(v) calcining the substrate obtained in (iv); and
(vi) optionally, repeating (iii) through (v) one or more times.

In some embodiments, the drying is performed at a temperature of from about 100 to about 150° C. In some embodiments, the calcination is performed at a temperature of from about 400 to about 600° C.

In some embodiments, the substrate is a flow-through or a wall-flow filter.

In another aspect is provided a treated zeolite, said treated zeolite being obtained or obtainable by the process disclosed herein.

In some embodiments, the efficiency of metal ion exchange into the zeolite, defined as the ratio of exchanged metal ion over the total metal ion, as determined by combined ammonia back-exchange and inductively coupled plasma-optical emission spectrometry (ICP-OES), is greater than 80%.

In some embodiments, a powder sample of the treated zeolite, after 2 hours aging at 450° C., exhibits a higher H₂ consumption below 300° C. and a lower starting temperature of a 1^{st} H₂-TPR peak relative to a treated zeolite prepared by a process wherein the metal ion source is an acetate salt of copper, iron, or a mixture thereof.

In some embodiments, a powder sample of the treated zeolite is characterized as having a higher percentage of exchanged copper ions relative to a treated zeolite prepared by a process wherein the metal ion source is an acetate salt of copper, as determined by peak area of metal ion signals from T-O-T bonds in a diffuse reflectance infrared Fourier transform spectrogram.

In a further aspect is provided an SCR or SCRoF catalyst article comprising a substrate and a treated zeolite disposed on at least a portion thereof, the substrate comprising an inlet end, an outlet end, an axial length extending from the inlet end to the outlet end, and a plurality of passages defined by internal walls of the substrate extending therethrough, said SCR or SCRoF catalyst article being obtained or obtainable by a process as disclosed herein.

In some embodiments, the conversion of NOₓ to nitrogen at 250° C. of the SCR or SCRoF catalyst article is enhanced relative to an SCR or SCRoF catalyst article wherein the treated zeolite is prepared by a process wherein the metal ion source is an acetate salt of copper.

### BRIEF DESCRIPTION OF THE DRAWINGS

In order to provide an understanding of embodiments of the invention, reference is made to the appended drawings, in which reference numerals refer to components of exemplary embodiments of the invention. The drawings are exemplary only, and should not be construed as limiting the invention. The disclosure described herein is illustrated by way of example and not by way of limitation in the accompanying figures. For simplicity and clarity of illustration, features illustrated in the figures are not necessarily drawn to scale. For example, the dimensions of some features may be exaggerated relative to other features for clarity. Further, where considered appropriate, reference labels have been repeated among the figures to indicate corresponding or analogous elements.

FIG. 1a is a perspective view of a wall-flow filter substrate;

FIG. 1b is a cross-sectional view of a section of a wall-flow filter substrate; and

FIG. 2 is a cutaway view of a section enlarged relative to FIG. 1a, wherein the honeycomb-type substrate in FIG. 1a represents a wall-flow filter;

FIGS. 3a, 3b, and 3c are illustrations of three possible coating configurations according to certain embodiments;

FIG. 4 shows a schematic depiction of an embodiment of an emission treatment system in which an SCR catalyst article of the present invention is utilized; and

FIG. 5 is a plot of temperature programmed reduction (TPR) data for certain embodiments.

### DETAILED DESCRIPTION

The present disclosure generally relates to a process for preparing advanced selective catalytic reduction (SCR) catalysts and selective catalytic reduction on filter (SCRoF) catalysts, and articles comprising the SCR or SCRoF catalysts prepared according to the disclosed process. Surprisingly, it was found that the in-situ ion exchange process disclosed herein provides higher efficiency of metal ion-exchange into a zeolite, and provides SCR and SCRoF catalysts with higher metal ion incorporation, relative to previous ion-exchange processes. The metal ion-exchanged zeolite SCR and SCRoF catalysts so prepared achieve high catalytic activities, such as significantly increased NOₓ conversion at any temperature, and especially at low temperature, relative to standard Cu-chabazite reference SCR catalysts.

### Definitions

The articles “a” and “an” herein refer to one or to more than one (e.g. at least one) of the grammatical object. Any ranges cited herein are inclusive. The term “about” used throughout is used to describe and account for small fluctuations. For instance, “about” may mean the numeric value may be modified by ±5%, ±4%, ±3%, ±2%, ±1%, ±0.5%, ±0.4%, ±0.3%, ±0.2%, ±0.1% or ±0.05%. All numeric values are modified by the term “about” whether or not explicitly indicated. Numeric values modified by the term “about” include the specific identified value. For example “about 5.0” includes 5.0. Recitation of ranges of values herein are merely intended to serve as a shorthand method of referring individually to each separate value falling within the range, unless otherwise indicated herein, and each separate value is incorporated into the specification as if it were individually recited herein.

The term “abatement” means a decrease in the amount, caused by any means.

“AMOx” refers to a selective ammonia oxidation catalyst, which is a catalyst containing one or more metals (typically Pt, although not limited thereto) and an SCR catalyst suitable to convert ammonia to nitrogen.

The term “associated” means for instance “equipped with”, “connected to” or in “communication with”, for example “electrically connected” or in “fluid communication with” or otherwise connected in a way to perform a function. The term “associated” may mean directly associated with or indirectly associated with, for instance through one or more other articles or elements.

“Average particle size” is synonymous with D50, meaning half of the population of particles has a particle size above this point, and half below. Particle size refers to primary particles. Particle size may be measured by laser light scattering techniques, with dispersions or dry powders, for example according to ASTM method D4464. D90 particle size distribution indicates that 90% of the particles (by number) have a Feret diameter below a certain size as measured by Scanning Electron Microscopy (SEM) or Transmission Electron Microscopy (TEM) for submicron size particles; and a particle size analyzer for the support-containing particles (micron size).

As used herein, the term “BET surface area” has its usual meaning of referring to the Brunauer, Emmett, Teller method for determining surface area by N₂ adsorption. Pore diameter and pore volume can also be determined using BET-type N₂ adsorption or desorption experiments.

The term “catalyst” refers to a material that promotes a chemical reaction. The catalytically active species are also termed “promoters” as they promote chemical reactions.

The term “catalytic article” or “catalyst article” refers to a component that is used to promote a desired reaction. The present catalytic articles comprise a “substrate” having at least one catalytic coating disposed thereon.

“Crystal size” as used herein means the length of one edge of a face of the crystal, preferably the longest edge, provided that the crystals are not needle-shaped. Direct measurement of the crystal size can be performed using microscopy methods, such as SEM and TEM. For example, measurement by SEM involves examining the morphology of materials at high magnifications (typically 1000× to 10,000×). The SEM method can be performed by distributing a representative portion of the zeolite powder on a suitable mount such that individual particles are reasonably evenly spread out across the field of view at 1000× to 10,000× magnification. From this population, a statistically significant sample of random individual crystals (e.g., 50-200) are examined and the longest dimensions of the individual crystals parallel to the horizontal line of the straight edge are measured and recorded. Particles that are clearly large polycrystalline aggregates are not to be included in the measurements. Based on these measurements, the arithmetic mean of the sample crystal sizes is calculated.

“CSF” refers to a catalyzed soot filter, which is a wall-flow monolith. A wall-flow filter consists of alternating inlet channels and outlet channels, where the inlet channels are plugged on the outlet end and the outlet channels are plugged on the inlet end. A soot-carrying exhaust gas stream entering the inlet channels is forced to pass through the filter walls before exiting from the outlet channels. In addition to soot filtration and regeneration, a CSF may carry oxidation catalysts to oxidize CO and HC to CO₂ and H₂O, or oxidize NO to NO₂ to accelerate the downstream SCR catalysis or to facilitate the oxidation of soot particles at lower temperatures. A CSF, when positioned behind a LNT catalyst, can have a H₂S oxidation functionality to suppress H₂S emission during the LNT desulfation process. An SCR catalyst composition can also coated directly onto a wall-flow filter, which is referred to as SCRoF.

“DOC” refers to a diesel oxidation catalyst, which converts hydrocarbons and carbon monoxide in the exhaust gas of a diesel engine. Typically, a DOC comprises one or more platinum group metals such as palladium and/or platinum; a support material such as alumina; zeolites for HC storage; and optionally promoters and/or stabilizers.

In general, the term “effective” means for example from about 35% to 100% effective, for instance from about 40%, about 45%, about 50% or about 55% to about 60%, about 65%, about 70%, about 75%, about 80%, about 85%, about 90% or about 95%, regarding the defined catalytic activity or storage/release activity, by weight or by moles.

The term “exhaust stream” or “exhaust gas stream” refers to any combination of flowing gas that may contain solid or liquid particulate matter. The stream comprises gaseous components and is for example exhaust of a lean burn engine, which may contain certain non-gaseous components such as liquid droplets, solid particulates and the like. The exhaust gas stream of a combustion engine typically further comprises combustion products (CO₂ and H₂O), products of incomplete combustion (carbon monoxide (CO) and hydrocarbons (HC)), oxides of nitrogen (NOₓ), combustible and/or carbonaceous particulate matter (soot), and unreacted oxygen and nitrogen.

“GDI” refers to a gasoline direct injection gasoline engine, which operates under lean burn conditions.

“High surface area refractory metal oxide supports” refer specifically to support particles having pores larger than 20 Å and a wide pore distribution. High surface area refractory metal oxide supports, e.g., alumina support materials, also referred to as “gamma alumina” or “activated alumina,” typically exhibit a BET surface area of fresh material in excess of 60 square meters per gram (“m²/g”), often up to about 200 m²/g or higher. Such activated alumina is usually a mixture of the gamma and delta phases of alumina, but may also contain substantial amounts of eta, kappa and theta alumina phases.

As used herein, “impregnated” or “impregnation” refers to permeation of the catalytic material into the porous structure of the support material.

The term “in fluid communication” is used to refer to articles positioned on the same exhaust line, i.e., a common exhaust stream passes through articles that are in fluid communication with each other. Articles in fluid communication may be adjacent to each other in the exhaust line. Alternatively, articles in fluid communication may be separated by one or more articles, also referred to as “washcoated monoliths.”

As used herein, the term “intra-pore site” refers to sites available for cations within the pore structure of zeolites. Zeolites are microporous solids containing pores and channels of various dimensions. A wide variety of cations can occupy these pores and can move through these channels. Intra-pore sites refer to all the internal spaces within the pore structure of the zeolite that can be occupied by cations such as for example exchange sites and/or defect sites. “Exchange sites” refers to sites available for cations, which are mainly occupied by ion-exchanged metal cations, which are intentionally added to the zeolite in order to promote a chemical reaction and are often referred to as the active metal. “Defect sites” refer to intra-pore sites, where part of the Si—O—Al framework of the zeolite has been damaged such that Al—O bonds have been broken and have been replaced with silanol functional groups (e.g., at least one but no more than four silanol groups, Si—OH) to generate an empty space or cavity. These sites are often occupied by copper oxide molecules with much weaker interaction and upon heating these ions easily move away, forming metal oxide clusters.

“LNT” refers to a lean NOₓ trap, which is a catalyst containing a platinum group metal, ceria, and an alkaline earth trap material suitable to adsorb NOₓ during lean conditions (for example, BaO or MgO). Under rich conditions, NOₓ is released and reduced to nitrogen.

As used herein, the phrase “molecular sieve” refers to framework materials such as zeolites and other framework materials (e.g. isomorphously substituted materials), which may in particulate form, and in combination with one or more promoter metals, be used as catalysts. Molecular sieves are materials based on an extensive three-dimensional network of oxygen ions containing generally tetrahedral type sites and having a substantially uniform pore distribution, with the average pore size being no larger than 20 Å.

Molecular sieves can be differentiated mainly according to the geometry of the voids which are formed by the rigid network of the (SiO₄)/AlO₄ tetrahedra. The entrances to the voids are formed from 6, 8, 10, or 12 ring atoms with respect to the atoms which form the entrance opening. Molecular sieves are crystalline materials having rather uniform pore sizes which, depending upon the type of molecular sieves and the type and amount of cations included in the molecular sieves lattice, range from about 3 to 10 Å in diameter. CHA is an example of an “8-ring” molecular sieve having 8-ring pore openings and double-six ring secondary building units and having a cage like structure resulting from the connection of double six-ring building units by 4 ring connections. Molecular sieves comprise small pore, medium pore and large pore molecular sieves or combinations thereof. The pore sizes are defined by the largest ring size.

The term “NOₓ” refers to nitrogen oxide compounds, such as NO, NO₂ or N₂O .

The terms “on” and “over” in reference to a coating layer may be used synonymously. The term “directly on” means in direct contact with. The disclosed articles are referred to in certain embodiments as comprising one coating layer “on” a second coating layer, and such language is intended to encompass embodiments with intervening layers, where direct contact between the coating layers is not required (i.e., “on” is not equated with “directly on”).

As used herein, the term “promoted” refers to a component that is intentionally added to, e.g., a zeolitic material, typically through ion exchange, as opposed to impurities inherent in the zeolite. A zeolite may, for example, be promoted with copper (Cu) and/or iron (Fe), although other catalytic metals could be used, such as manganese, cobalt, nickel, cerium, platinum, palladium, rhodium or combinations thereof.

The term “promoter metal(s)” in the contest of zeolite SCR catalysts refers to one or more metals added to an ion-exchanged zeolite to generate a modified “metal-promoted” molecular sieve. The promoter metal is added to the ion-exchanged zeolite to enhance the catalytic activity of the active metal residing at the exchange site in the zeolite compared to ion-exchanged zeolites that do not contain a promoter metal, e.g., the addition of aluminum or alumina oxide as a “promoter metal” to a copper ion-exchanged zeolite enhances the catalytic activity of copper by preventing and/or reducing the formation of catalytically less active copper oxide clusters.

As used herein, the term “selective catalytic reduction” (SCR) refers to the catalytic process of reducing oxides of nitrogen to dinitrogen (N₂) using a nitrogenous reductant.

“SCRoF” refers to an SCR catalyst composition coated directly onto a wall-flow filter.

“Substantially free” means “little or no” or “no intentionally added” and also having only trace and/or inadvertent amounts. For instance, in certain embodiments, “substantially free” means less than 2 wt % (weight %), less than 1.5 wt %, less than 1.0 wt %, less than 0.5 wt %, 0.25 wt % or less than 0.01 wt %, based on the weight of the indicated total composition.

As used herein, the term “substrate” refers to the monolithic material onto which the catalyst composition, that is, catalytic coating, is disposed, typically in the form of a washcoat. In one or more embodiments, the substrates are flow-through monoliths and monolithic wall-flow filters. Reference to “monolithic substrate” means a unitary structure that is homogeneous and continuous from inlet to outlet.

As used herein, the term “support” or “support material” refers to any material, typically a high surface area material, usually a refractory metal oxide material, upon which a metal is applied (e.g., PGMs, stabilizers, promoters, binders, and the like) through precipitation, association, dispersion, impregnation, or other suitable methods. Exemplary supports include porous refractory metal oxide supports as described herein below. The term “supported” means “dispersed on”, “incorporated into”, “impregnated into”, “on”, “in”, “deposited on” or otherwise associated with.

As used herein, the terms “upstream” and “downstream” refer to relative directions according to the flow of an engine exhaust gas stream from an engine towards a tailpipe, with the engine in an upstream location and the tailpipe and any pollution abatement articles such as filters and catalysts being downstream from the engine. The inlet end of a substrate is synonymous with the “upstream” end or “front” end. The outlet end is synonymous with the “downstream” end or “rear” end. An upstream zone is upstream of a downstream zone. An upstream zone may be closer to the engine or manifold, and a downstream zone may be further away from the engine or manifold.

“Washcoat” has its usual meaning in the art of a thin, adherent coating of a material (e.g., a catalyst) applied to a “substrate”, such as a honeycomb flow-through monolith substrate or a filter substrate which is sufficiently porous to permit the passage therethrough of the gas stream being treated. As used herein and as described in Heck, Ronald and Farrauto, Robert, Catalytic Air Pollution Control, New York: Wiley-Interscience, 2002, pp. 18-19, a washcoat layer includes a compositionally distinct layer of material disposed on the surface of a monolithic substrate or an underlying washcoat layer. A washcoat is formed by preparing a slurry containing a specified solids content (e.g., 10-50% by weight) of catalyst in a liquid, which is then coated onto a substrate and dried to provide a washcoat layer. A substrate can contain one or more washcoat layers, and each washcoat layer can be different in some way (e.g., may differ in physical properties thereof such as, for example particle size or crystallite phase) and/or may differ in the chemical catalytic functions.

As used herein, the term “zeolite” refers to a specific example of a molecular sieve, further including silicon and aluminum atoms. Generally, a zeolite is defined as an aluminosilicate with an open 3-dimensional framework structure composed of corner-sharing TO₄ tetrahedra, where T is Al or Si, or optionally P. A zeolite may comprise SiO₄/AlO₄ tetrahedra that are linked by common oxygen atoms to form a three-dimensional network. Cations that balance the charge of the anionic framework are loosely associated with the framework oxygens, and the remaining pore volume is filled with water molecules. The non-framework cations are generally exchangeable, and the water molecules removable. Aluminosilicate zeolite structures do not include phosphorus or other metals isomorphically substituted in the framework. That is, “aluminosilicate zeolite” excludes aluminophosphate materials such as SAPO, AlPO and MeAlPO materials, while the broader term “zeolite” includes aluminosilicates and aluminophosphates. For the purposes of this disclosure, SAPO, AlPO and MeAlPO materials are considered non-zeolitic molecular sieves.

Zeolites are microporous solids containing pores and channels of various dimensions. Cations that balance the charge of the anionic framework are loosely associated with the framework oxygens, and the remaining pore volume is filled with water molecules. The non-framework cations are generally exchangeable, and the water molecules removable. A wide variety of cations can occupy these pores and can move through these channels. As used herein, the term “intra-pore site” refers to sites available for cations within the pore structure of zeolites. Intra-pore sites refer to all the internal spaces within the pore structure of the zeolite that can be occupied by cations such as for example exchange sites and/or defect sites. “Exchange sites” refers to sites available for cations, which are mainly occupied by ion-exchanged metal cations (e.g., Cu or Fe), which are intentionally added to the zeolite in order to adsorb to promote a chemical reaction.

Unless otherwise indicated, all parts and percentages are by weight. “Weight percent (wt %),” if not otherwise indicated, is based on an entire composition free of any volatiles, that is, based on dry solids content.

All methods described herein can be performed in any suitable order unless otherwise indicated herein or otherwise clearly contradicted by context. The use of any and all examples, or exemplary language (e.g., “such as”) provided herein, is intended merely to better illuminate the materials and methods and does not pose a limitation on the scope unless otherwise claimed. No language in the specification should be construed as indicating any non-claimed element as essential to the practice of the disclosed materials and methods.

All U.S. patent applications, published patent applications and patents referred to herein are hereby incorporated by reference.

### I. Process for Preparing a SCR or SCRoF Catalyst, and SCR or SCRoF Catalysts Prepared According to the Disclosed Process

In one aspect of the disclosure is provided a process for preparing a selective catalytic reduction (SCR) catalyst or a selective catalytic reduction on filter (SCRoF) catalyst, said SCR or SCRoF catalyst comprising a metal ion-exchanged zeolite. The process comprises:
(i) admixing a zeolite with an aqueous mixture comprising water and a metal ion source comprising a carbonate salt of copper, iron, or a mixture thereof, to form a slurry comprising a treated zeolite.

### Aqueous Mixture

In some embodiments, the aqueous mixture comprises water and a metal ion source comprising a carbonate salt of copper, iron, or a mixture thereof. The components of the first aqueous mixture are described in detail herein below.

### Metal Ion Source

As disclosed herein, the process for preparing a SCR catalyst or a SCRoF catalyst requires a metal ion source comprising a carbonate salt of copper, iron, or a mixture thereof. In some embodiments, the metal ion source is a copper carbonate. In some embodiments, the metal ion source is a copper carbonate. In some embodiments, the metal ion source is basic copper carbonate (Cu(OH)₂.Cu(CO₃)). In some embodiments, the metal ion source is an iron carbonate (Fe(CO₃) or Fe₂(CO₃)₃). In some embodiments, the metal ion source further comprises one or more of copper oxide, copper hydroxide, copper nitrate, copper chloride, copper acetate, copper acetylacetonate, copper oxalate, or copper sulfate.

In some embodiments, the method further comprises milling the aqueous mixture prior to performing the admixing step. In some embodiments, the aqueous mixture comprises particles of the metal ion source having a D90 value of from about 0.5 to about 20 micrometers. D90 is defined as the particle size at which 90% of the particles have a finer particle size. In some embodiments, the aqueous mixture comprises particles of the metal ion source having a D90 value of from about 4 to about 10 micrometers. In some embodiments, the aqueous mixture comprises particles of the metal ion source having a D50 value of from about 1 to about 3 micrometers. D50 is defined as the particle size at which 50% of the particles have a finer particle size.

The solids content of the aqueous mixture may vary, and may be in the range of, for example, from about 4 to about 30% by weight.

In some embodiments, the aqueous mixture further comprises one or more additives selected from one or more of a sugar, a dispersing agent, a surface tension reducer, a rheology modifier, or a combination thereof.

### Zeolite

As described herein above, the term zeolite refers to a specific example of a molecular sieve, further including silicon and aluminum atoms. According to one or more embodiments, the zeolite can be based on the framework topology by which the structures are identified. Typically, any structure type of zeolite can be used, such as structure types of ABW, ACO, AEI, AEL, AEN, AET, AFG, AFI, AFN, AFO, AFR, AFS, AFT, AFX, AFY, AHT, ANA, APC, APD, AST, ASV, ATN, ATO, ATS, ATT, ATV, AWO, AWW, BCT, BEA, BEC, BIK, BOG, BPH, BRE, CAN, CAS, SCO, CFI, SGF, CGS, CHA, CHI, CLO, CON, CZP, DAC, DDR, DFO, DFT, DOH, DON, EAB, EDI, EMT, EON, EPI, ERI, ESV, ETR, EUO, FAU, FER, FRA, GIS, GIU, GME, GON, GOO, HEU, IFR, IHW, ISV, ITE, ITH, ITW, IWR, IWW, JBW, KFI, LAU, LEV, LIO, LIT, LOS, LOV, LTA, LTL, LTN, MAR, MAZ, MEI, MEL, MEP, MER, MFI, MFS, MON, MOR, MOZ, MSO, MTF, MTN, MTT, MTW, MWW, NAB, NAT, NES, NON, NPO, NSI, OBW, OFF, OSI, OSO, OWE, PAR, PAU, PHI, PON, RHO, RON, RRO, RSN, RTE, RTH, RUT, RWR, RWY, SAO, SAS, SAT, SAV, SBE, SBS, SBT, SFE, SFF, SFG, SFH, SFN, SFO, SGT, SOD, SOS, SSY, STF, STI, STT, TER, THO, TON, TSC, UEI, UFI, UOZ, USI, UTL, VET, VFI, VNI, VSV, WIE, WEN, YUG, ZON, or combinations thereof.

Present zeolites may be small pore, medium pore, or large pore zeolites.

A small pore zeolite contains channels defined by up to eight tetrahedral atoms. As used herein, the term “small pore” refers to pore openings which are smaller than about 5 Angstroms, for example on the order of ˜3.8 Angstroms. Exemplary small pore zeolites include framework types ACO, AEI, AEN, AFN, AFT, AFX, ANA, APC, APD, ATT, CDO, CHA, DDR, DFT, EAB, EDI, EPI, ERI, GIS, GOO, IHW, ITE, ITW, LEV, KFI, MER, MON, NSI, OWE, PAU, PHI, RHO, RTH, SAT, SAV, SIV, THO, TSC, UEI, UFI, VNI, YUG, ZON and mixtures or intergrowths thereof.

A medium pore zeolite contains channels defined by ten-membered rings. Exemplary medium pore zeolites include framework types AEL, AFO, AHT, BOF, BOZ, CGF, CGS, CHI, DAC, EUO, FER, HEU, IMF, ITH, ITR, JRY, JSR, JST, LAU, LOV, MEL, MFI, MFS, MRE, MTT, MVY, MWW, NAB, NAT, NES, OBW, PAR, PCR, PON, PUN, RRO, RSN, SFF, SFG, STF, STI, STT, STW, SVR, SZR, TER, TON, TUN, UOS, VSV, WEI, WEN and mixtures or intergrowths thereof.

A large pore zeolite contains channels defined by twelve-membered rings. Exemplary large pore zeolites include framework types AFI, AFR, AFS, AFY, ASV, ATO, ATS, BEA, BEC, BOG, BPH, BSV, CAN, CON, CZP, DFO, EMT, EON, EZT, FAU, GME, GON, IFR, ISV, ITG, IWR, IWS, IWV, IWW, JSR, LTF, LTL, MAZ, MEI, MOR, MOZ, MSE, MTW, NPO, OFF, OKO, OSI, RON, RWY, SAF, SAO, SBE, SBS, SBT, SEW, SFE, SFO, SFS, SFV, SOF, SOS, STO, SSF, SSY, USI, UWY, VET and mixtures or intergrowths thereof.

In some embodiments, the zeolite has a framework structure type selected from the group consisting of CHA, AEI, RTH, AFX, a mixture of two or more thereof and a mixed type of two or more thereof. In some embodiments, the zeolite has a framework structure type selected from the group consisting of CHA and AEI. In some embodiments, the zeolite has a framework type CHA. In some embodiments, the zeolite is SSZ-13.

The molar ratio of silica-to-alumina (“SAR”) of a present zeolite can vary over a wide range, but is generally 2 or greater. For instance, a present zeolite may have a SAR of from about 5 to about 1000. In one or more embodiments, the zeolite has a silica-to-alumina (SAR) molar ratio in the range of 2 to 300, including 5 to 250; 5 to 200; 5 to 100; and 5 to 50. In some embodiments, the zeolite has a SAR in the range of 10 to 200, 10 to 100, 10 to 75, 10 to 60, and 10 to 50; 15 to 100, 15 to 75, 15 to 60, and 15 to 50; 20 to 100, 20 to 75, 20 to 60, and 20 to 50. In some embodiments, the molar ratio of silica to alumina (SiO₂:Al₂O₃), is from about 2 to about 50. In some embodiments, the molar ratio of SiO₂ to Al₂O₃ is about 25.

In some embodiments, the zeolite, prior to admixing with the aqueous mixture, is in the H-form. In some embodiments, the zeolite, prior to admixing with the aqueous mixture, is in the NH₄⁺-form. In some embodiments, the zeolite, prior to admixing with the aqueous mixture, comprises an amount of copper, for example, from about 0 wt % to about 1.25 wt % of copper, calculated as CuO based on the weight of the zeolite. In other words, the zeolite, prior to the admixing step, may have been previously ion-exchanged with a low level of copper.

The particle size of the zeolite can vary. Generally, the particle size of the zeolite can be characterized by a D90 particle size of about 1 to about 40 micrometers, from about 1 to about 20 micrometers, or from about 1 to about 10 micrometers. In some embodiments, the zeolite of the second aqueous mixture comprises particles having a D50 value of from about 1 to about 5 micrometers, and a D90 value of from about 4 to about 10 micrometers.

The present zeolites may exhibit a high surface area, for example a BET surface area, determined according to DIN 66131, of at least about 200 m²/g, at least about 400 m²/g, at least about 500 m²/g, or at least about 750, or at least about 1000 m²/g, for example from about 200 to about 1000 m²/g, or from about 500 to about 750 m²/g. “BET surface area” has its usual meaning of referring to the Brunauer, Emmett, Teller method for determining surface area by N₂ adsorption. In one or more embodiments the BET surface area is from about 550 to about 700 m²/g.

### Binder

In some embodiments, the admixing step further comprises adding a binder during the admixing step. Binders provide a catalyst that remains homogeneous and intact after thermal aging, for example, when the catalyst is exposed to high temperatures of at least about 600° C., for example, about 800° C. and higher, and high water vapor environments of about 5% or more. In some embodiments, the binder comprises an oxide of Al, Si, Ti, Zr, Ce, or a mixture of two or more thereof. In some embodiments, the binder comprises alumina, silica, a mixture thereof, or a mixed oxide comprising Al and Si. In some embodiments, the binder is a mixture of alumina and silica. Alumina binders include aluminum oxides, aluminum hydroxides and aluminum oxyhydroxides. Aluminum salts and colloidal forms of alumina many also be used. Silica binders include various forms of SiO₂, including silicates and colloidal silica.

The particle size of the binder may vary. Generally, the particle size of the binder can be characterized by a D90 particle size of about 0.1 to about 40 micrometers, from about 0.1 to about 30 micrometers, or from about 0.1 to about 25 micrometers. In some embodiments, the binder comprises particles having a D90 value of from about 0.5 to about 20 micrometers.

The binder may exhibit a high surface area, for example a BET surface area, determined according to DIN 66131, of at least about 200 m²/g, at least about 400 m²/g, at least about 500 m²/g, at least about 750, or at least about 1000 m²/g, for example from about 200 to about 1000 m²/g, or from about 500 to about 750 m²/g. In one or more embodiments the BET surface area of the binder is from about 550 to about 700 m²/g.

### Admixing

The process as disclosed herein comprises admixing a zeolite with an aqueous mixture comprising water and a metal ion source comprising a carbonate salt of copper, iron, or a mixture thereof, to form a slurry comprising a treated zeolite.

The admixing step promotes the ion exchange reaction of the metal ion source with the zeolite. Without wishing to be bound by theory, it is believed that use of the carbonate salt of the metal ion source may facilitate the ion exchange reaction with the zeolite by releasing carbon dioxide (CO₂). The proposed ion exchange mechanism (“in situ ion exchange”) is illustrated in Equation 1:

H-Zeolite+Mₓ(CO₃)_{y}→M-Zeolite+H₂O+CO₂ (1)

where H-Zeolite represents the hydrogen ion form of the zeolite, M is the metal ion (e.g., copper, iron, or both) and x and y represent the stoichiometry of the metal ion source, which is determined by the valence of the metal ion. Without wishing to be bound by theory, it is believed that the ion exchange process at least begins during the admixing step, and the resulting slurry comprises an amount of metal ion-exchanged zeolite, referenced herein as a “treated zeolite.” The ion exchange process initiated in the admixing step may, however, proceed further during e.g., calcination or subsequent treatment steps.

In some embodiments, the zeolite can be ion-exchanged with copper. In some embodiments, the zeolite can be ion-exchanged with iron. In some embodiments, the zeolite can be ion-exchanged with both copper and iron. Where both metals are to be included in the metal ion-exchanged zeolite, multiple metal precursors (e.g., copper and iron precursors) can be ion-exchanged at the same time or separately. In certain embodiments, iron can be exchanged into a zeolite material that has first been promoted with copper (e.g., iron can be exchanged into a copper-promoted zeolite material). In certain embodiments, copper can be exchanged into a zeolite material that has first been promoted with iron (e.g., copper can be exchanged into an iron-promoted zeolite material). In some embodiments, copper and iron are exchanged into the zeolite simultaneously (i.e., the metal ion source is a mixture of basic copper carbonate and iron carbonate).

The admixing step can be carried out at various temperatures, for example, at an elevated temperature, to promote the ion exchange reaction. In some embodiments, the admixing is carried out at a temperature that is greater than about 10° C. and is less than the decomposition temperature of the metal carbonate salt that is being used. More particularly, the admixing can be carried out at a temperature of about 10° C. to about 150° C., about 20° C. to about 120° C., or about 30° C. to about 100° C. In certain embodiments, the temperature can be from about 10° C. to about 35° C., for example, about 20° C.

Preferably, the admixing is conducted at the above-noted temperature range for a time of about 5 minutes or more, about 10 minutes or more, about 15 minutes or more, about 30 minutes or more, or about 45 minutes or more, such as about 5 minutes to about 240 minutes, about 10 minutes to about 180 minutes, about 15 minutes to about 180 minutes, about 20 minutes to about 120 minutes, or about 30 minutes to about 90 minutes.

In some embodiments, the process may comprise further steps. For example, following the admixing step, and before or after the optional milling step, the slurry comprising particles of the treated (i.e., metal ion-exchanged) zeolite can be subject to one or more steps of filtering alone or in combination with washing. For example, the metal ion-exchanged zeolite can be filtered from the aqueous medium to provide the finished product. In some embodiments, washing and filtering can be carried out utilizing a filter press. In such methods, the metal ion-exchanged zeolite slurry is pumped into a filter press unit wherein the metal ion-exchanged zeolite solids collect on the filter webs. The increasing pressure on the filter webs as the solids are collected is beneficial to force non-solids through the web and into the filtrate. If desired, air may be forced through the filter cakes to further remove the non-solids. In one or more embodiments, filtering can be carried out with a funnel filter (e.g., a Buchner filter) and appropriate filter paper, and filtering may be augmented by application of a vacuum.

The filter cakes with the metal ion-exchanged zeolite can be washed by pumping of an aqueous solvent through the filter cakes on the webs. The aqueous solvent, in some embodiments, can be demineralized water. In some embodiments, washing can be carried out until the filtrate has a desired conductivity. Any recognized method for measuring filtrate conductivity can be utilized according to the present disclosure such as, for example, the methods described in ASTM D1125-14, Standard Test Methods for Electrical Conductivity and Resistivity of Water. Standard conductivity measurement devices, such as a VWR® Symphony™ Handheld Meter with a conductivity probe, can be used, preferably calibrating the device with a conductivity standard. Washing preferably can be carried out until the filtrate has a measured conductivity of about 400 micromhos or less, about 300 micromhos or less, about 250 micromhos or less, or about 200 micromhos or less, more particularly about 10 micromhos to about 400 micromhos, about 25 micromhos to about 300 micromhos, or about 50 micromhos to about 200 micromhos. In some embodiments, washing can be particularly used to remove a variety of ions from the solution, such as sodium, iron, copper, ammonium, and the like.

In some embodiments, the slurry comprising particles of the treated zeolite so obtained is milled to provide a particular particle size range, to enhance mixing of the particles, or to form a homogenous material. The milling can be accomplished in a ball mill, continuous mill, or other similar equipment. In some embodiments, the particles of the treated zeolite have a D90 value of from about 0.5 to about 20 micrometers.

The slurry may optionally contain various additional components. Typical additional components include, but are not limited to, binders as described herein, additives to control, e.g., pH and viscosity of the slurry. Additional components can include hydrocarbon (HC) storage components (e.g., zeolites), associative thickeners, and/or surfactants (including anionic, cationic, non-ionic or amphoteric surfactants). A typical pH range for the slurry is about 3 to about 6. Addition of acidic or basic species to the slurry can be carried out to adjust the pH accordingly. For example, in some embodiments, the pH of the slurry is adjusted by the addition of aqueous acetic acid.

The solids content of the slurry comprising particles of the treated zeolite may vary according to intended usage. In some embodiments, the slurry has a solid content of from about 15 to about 45 wt. %, based on the weight of said mixture.

Treated zeolite

In another aspect is provided a SCR or SCRoF catalyst comprising a treated zeolite, the treated zeolite prepared according to the process disclosed herein. Metal ion-exchanged zeolites prepared by this process may be characterized according to certain features. Many of these features are advantageous in providing SCR or SCRoF catalysts having high efficiency for NOₓ conversion, particularly at low temperatures.

Various base metal-promoted zeolites and methods of their preparation are well known. Generally, a base metal (e.g., copper, iron, or the like) is ion-exchanged into the zeolite. Such base metals are generally ion exchanged into alkali metal or NH₄⁺ zeolites (which can be prepared by NH₄⁺ ion exchange into an alkali metal zeolite by methods known in the art, e.g., as disclosed in Bleken, F. et al., Topics in Catalysis 2009, 52, 218-228, which is incorporated herein by reference). Without wishing to be bound by theory, it is believed that the presently disclosed method provides metal ion-exchanged zeolites with a higher metal ion concentration and/or a higher percentage of ion-exchanged metal (i.e., metal ions present in ion exchange sites within the zeolite), as compared to metal ion-exchanged zeolites produced by a comparable process not utilizing a carbonate salt, for example, using a conventional metal ion source such as an acetate salt of the metal.

The amount of metal ion exchanged in the metal ion-exchanged zeolite may vary. In some embodiments, the amount of metal comprised in the metal ion-exchanged zeolite is in the range of from about 1 to about 15 wt %, about 2 to about 10 wt %, about 2.5 to about 5.5 wt %, about 3 to about 5 wt %, or about 3.5 to about 4 wt %, based on the weight of the metal ion-exchanged zeolite and calculated as the metal oxide. In one or more specific embodiments, the ion-exchanged metal comprises Cu, and the Cu content of the metal ion exchanged zeolite, calculated as CuO, is in the range of up to about 10 wt %, including about 9, about 8, about 7, about 6, about 5, about 4, about 3, about 2, about 1, about 0.5, and about 0.1 wt %, on an oxide basis, in each case based on the weight of the final ion-exchanged zeolite and reported on a volatile-free basis.

The copper that is present in the metal ion-exchanged zeolite in certain embodiments as disclosed herein may be present as different species and may be distributed differently as described herein. In addition to the copper that is exchanged to increase the level of copper associated with the exchange sites in the structure of the zeolite, non-exchanged copper in salt form may be present in the zeolite as so called free copper. In some embodiments, no free copper is present in the zeolite. Surprisingly, according to the present disclosure, it has been found that the efficiency of metal ion-exchange into the zeolite, defined as the ratio of exchanged metal ion to the total metal ion, is in some embodiments, equal to or higher than the efficiency of metal ion exchange when traditional metal ion sources are utilized (e.g., acetate, nitrate, oxide, hydroxide). In some embodiments, the efficiency is greater than 80%. The efficiency of metal ion exchange may be determined by, for example, combined ammonia back-exchange and inductively coupled plasma-optical emission spectrometry (ICP-OES). In ammonia back-exchange, ion exchanged metal in the zeolitic material is removed, leaving un-exchanged residual metal in the form of the metal oxide. The amount of residual metal is determined by ICP-OES, and the difference in the metal concentration before and after the ammonia back-exchange is the amount of ion-exchanged metal. In some embodiments, the metal ion-exchanged zeolite as disclosed herein shows a weight ratio of ion-exchanged metal to metal oxide of at least about 1, measured after calcination of the zeolite at 450° C. in air for 1 hour in some embodiments, the ratio is at least about 1.5. In some embodiments, the ratio is at least about 2. In some embodiments, the metal is copper and the ratio of ion-exchanged Cu to CuO is at least about 2.

Copper species (e.g., copper oxide, metal, and ion-exchanged copper) which may be present in a zeolitic material can be identified by monitoring the perturbed T-O-T bond (Si—O—Al and Si—O—Si) vibrations by diffuse reflectance Fourier transform infrared (DRIFT) spectroscopy. The use of this FTIR technique has been demonstrated in the literature, in for example, Giamello et al., J. Catal. 136, 510-520 (1992). The structural vibrations of T-O-T bonds in zeolites have absorption peaks at 1300-1000 cm⁻¹ and 850-750 cm⁻¹ for the asymmetric and symmetric vibration mode, respectively. The frequency of asymmetric T-O-T vibration of the oxygen containing ring is sensitive to the interaction with cations, and therefore the IR band shifts from typical 1000-1300 cm⁻¹ (position characteristic of unperturbed ring) to about 850-1000 cm⁻¹ when interacting with a cation. The shifted band appears in the transmission window between two strong bands of T-O-T asymmetric and symmetric vibrations. The position of such a shifted band depends on the properties of the cations. Such perturbed T-O-T bond vibrations are observed when copper ions are exchanged into the cationic exchange position of zeolite framework structures, due to strong interaction between copper ions and neighboring oxygen atoms in the framework structure. The peak position depends on the status of compensated cations and the structure of the zeolite framework. The peak intensity depends on the quantity of compensated cations in the exchanged sites. In some embodiments, a powder sample of the metal ion-exchanged zeolite as disclosed herein exhibits a higher peak area of metal ion signal from T-O-T bond as measured by DRIFT spectroscopy relative to a metal ion-exchanged zeolite prepared by a process wherein the metal ion source is e.g., an acetate salt of copper.

Surprisingly, according to the present disclosure, it has further been found that the treated (i.e., metal ion-exchanged) zeolites prepared according to the process disclosed herein, in some embodiments, exhibit improved SCR catalytic properties relative to metal ion-exchanged zeolites prepared according to conventional processes. Without wishing to be bound by theory, it is believed that an enhanced concentration of metal ions within the ion exchange sites of the zeolite contributes to this enhanced activity.

Temperature programmed reduction (TPR) is a method for characterizing quantitatively the reducibility of a metal species-containing compound by hydrogen consumption. The species of metal undergoing reduction includes both metal ions and metal oxides (e.g., Cu⁺², Cu⁺¹, and CuO). Generally, a reducing gas mixture (typically 3% to 17% hydrogen diluted in argon or nitrogen) flows over the sample. A thermal conductivity detector (TCD) is used to measure changes in the thermal conductivity of the gas stream to provide hydrogen consumption data as a function of time and temperature. The use of this technique for the evaluation of metal-containing zeolites has been demonstrated in the literature, e.g., in bran et al., Journal of Catalysis, 161, 43-54 (1996). A higher total hydrogen consumption and lower temperature for the start of hydrogen absorption are generally correlated with increased overall and low temperature catalytic activity. In some embodiments, a powder sample of the metal ion-exchanged zeolite of the present disclosure, after 2 hours aging at 450° C., exhibits a higher H₂ consumption below 300° C. and a lower starting temperature of a 1^{st} H₂-TPR peak, relative to a metal ion-exchanged zeolite prepared by a process wherein the metal ion source is an acetate salt of copper.

### II. Process For Preparing SCR or SCRoF Catalytic Articles, and SCR or SCRoF Articles Prepared According To the Disclosed Process

In some embodiments, the process for preparing a selective catalytic reduction (SCR) catalyst or a selective catalytic reduction on filter (SCRoF) catalyst as disclosed herein further comprises steps directed to the preparation of SCR or SCRoF catalyst articles comprising a substrate and the treated zeolite prepared as disclosed herein. In some embodiments are provided SCR or SCRoF catalyst articles prepared according to the process disclosed herein.

In some embodiments, the process for preparing a SCR catalyst or a SCRoF catalyst as disclosed herein further comprises:
(ii) optionally, milling the slurry comprising the treated zeolite;
(iii) contacting a substrate with the slurry comprising the treated zeolite to form
   a coating on the substrate, the substrate comprising an inlet end, an outlet end, an axial length extending from the inlet end to the outlet end, and a plurality of passages defined by internal walls of the substrate extending therethrough;
(iv) drying the coated substrate;
(v) calcining the coated substrate obtained in (iv); and
(vi) optionally, repeating (iii) through (v) one or more times.

The process and the components of the SCR catalyst or SCRoF catalyst so obtained are described in detail herein below.

### Substrates

In one or more embodiments, the present SCR catalyst or SCRoF catalysts are disposed on a substrate to form a SCR catalyst or SCRoF catalytic article. Catalytic articles comprising the substrates are generally employed as part of an exhaust gas treatment system (e.g., catalyst articles including, but not limited to, articles including the SCR catalyst or SCRoF catalysts disclosed herein). Useful substrates are 3-dimensional, having a length and a diameter and a volume, similar to a cylinder. The shape does not necessarily have to conform to a cylinder. The length is an axial length defined by an inlet end and an outlet end.

According to one or more embodiments, the substrate for the disclosed catalyst(s) may be constructed of any material typically used for preparing automotive catalysts and will typically comprise a metal or ceramic honeycomb structure. The substrate typically provides a plurality of wall surfaces upon which the washcoat composition is applied and adhered, thereby acting as a substrate for the catalyst.

Ceramic substrates may be made of any suitable refractory material, e.g. cordierite, cordierite-α-alumina, aluminum titanate, silicon titanate, silicon carbide, silicon nitride, zircon mullite, spodumene, alumina-silica-magnesia, zircon silicate, sillimanite, a magnesium silicate, zircon, petalite, α-alumina, an aluminosilicate and the like.

Substrates may also be metallic, comprising one or more metals or metal alloys. A metallic substrate may include any metallic substrate, such as those with openings or “punch-outs” in the channel walls. The metallic substrates may be employed in various shapes such as pellets, compressed metallic fibers, corrugated sheet or monolithic foam. Specific examples of metallic substrates include heat-resistant, base-metal alloys, especially those in which iron is a substantial or major component. Such alloys may contain one or more of nickel, chromium, and aluminum, and the total of these metals may advantageously comprise at least about 15 wt % (weight percent) of the alloy, for instance, about 10 to about 25 wt % chromium, about 1 to about 8 wt % of aluminum, and from 0 to about 20 wt % of nickel, in each case based on the weight of the substrate. Examples of metallic substrates include those having straight channels; those having protruding blades along the axial channels to disrupt gas flow and to open communication of gas flow between channels; and those having blades and also holes to enhance gas transport between channels allowing for radial gas transport throughout the monolith.

Any suitable substrate for the catalytic articles disclosed herein may be employed, such as a monolithic substrate of the type having fine, parallel gas flow passages extending there through from an inlet or an outlet face of the substrate such that passages are open to fluid flow there through (“flow-through substrate”). Another suitable substrate is of the type have a plurality of fine, substantially parallel gas flow passages extending along the longitudinal axis of the substrate where, typically, each passage is blocked at one end of the substrate body, with alternate passages blocked at opposite end-faces (“wall-flow filter”). Flow-through and wall-flow substrates are also taught, for example, in International Application Publication No. WO2016/070090, which is incorporated herein by reference in its entirety.

In some embodiments, the catalyst substrate comprises a honeycomb substrate in the form of a wall-flow filter or a flow-through substrate. In some embodiments, the substrate is a wall-flow filter. In some embodiments, the substrate is a flow-through substrate. Flow-through substrates and wall-flow filters will be further discussed herein below.

### Flow-Through Substrates

In some embodiments, the substrate is a flow-through substrate (e.g., monolithic substrate, including a flow-through honeycomb monolithic substrate). Flow-through substrates have fine, parallel gas flow passages extending from an inlet end to an outlet end of the substrate such that passages are open to fluid flow. The passages, which are essentially straight paths from their fluid inlet to their fluid outlet, are defined by walls on or in which a catalytic coating is disposed so that gases flowing through the passages contact the catalytic material. The flow passages of the flow-through substrate are thin-walled channels, which can be of any suitable cross-sectional shape and size such as trapezoidal, rectangular, square, sinusoidal, hexagonal, oval, circular, etc. The flow-through substrate can be ceramic or metallic as described above.

Flow-through substrates can, for example, have a volume of from about 50 in³ to about 1200 in³, a cell density (inlet openings) of from about 60 cells per square inch (cpsi) to about 500 cpsi or up to about 900 cpsi, for example from about 200 to about 400 cpsi and a wall thickness of from about 50 to about 200 microns or about 400 microns.

### Wall-Flow Filter Substrates

In some embodiments, the substrate is a wall-flow filter, which generally has a plurality of fine, substantially parallel gas flow passages extending along the longitudinal axis of the substrate. Typically, each passage is blocked at one end of the substrate body, with alternate passages blocked at opposite end-faces. Such monolithic wall-flow filter substrates may contain up to about 900 or more flow passages (or “cells”) per square inch of cross-section, although far fewer may be used. For example, the substrate may have from about 7 to 600, more usually from about 100 to 400, cells per square inch (“cpsi”). The cells can have cross-sections that are rectangular, square, circular, oval, triangular, hexagonal, or are of other polygonal shapes. The wall-flow filter substrate can be ceramic or metallic as described above.

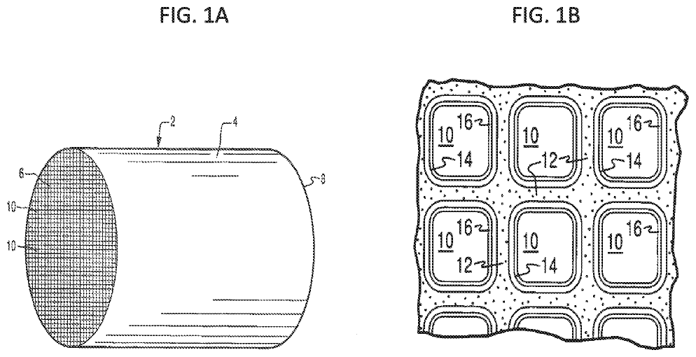

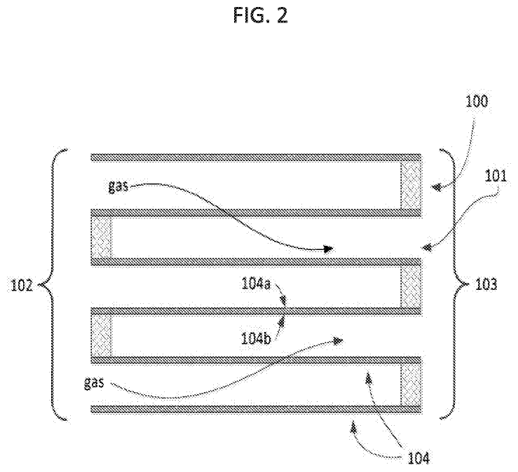

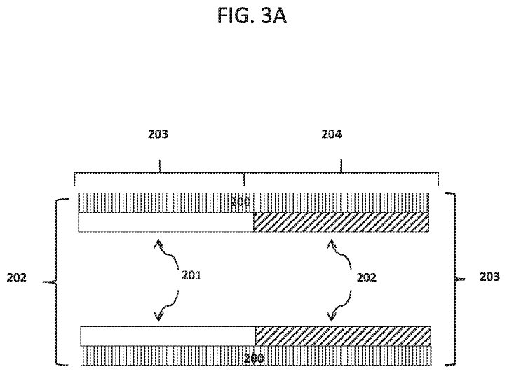

Referring to FIG. 1a, the exemplary wall-flow filter substrate has a cylindrical shape and a cylindrical outer surface having a diameter D and an axial length L. FIG. 1b is a perspective view of an exemplary wall-flow filter. A cross-section view of a monolithic wall-flow filter substrate section is illustrated in FIG. 1b, showing alternating plugged and open passages (cells). Blocked or plugged ends 100 alternate with open passages 101, with each opposing end open and blocked, respectively. The filter has an inlet end 102 and outlet end 103. The arrows crossing porous cell walls 104 represent exhaust gas flow entering the open cell ends, diffusion through the porous cell walls 104 and exiting the open outlet cell ends. Plugged ends 100 prevent gas flow and encourage diffusion through the cell walls. Each cell wall will have an inlet side 104a and outlet side 104b. The passages are enclosed by the cell walls.

The wall-flow filter article substrate may have a volume of, for instance, from about 50 cm³, about 100 in³, about 200 in³, about 300 in³, about 400 in³, about 500 in³, about 600 in³, about 700 in³, about 800 in³, about 900 in³ or about 1000 in³ to about 1500 in³, about 2000 in³, about 2500 in³, about 3000 in³, about 3500 in³, about 4000 in³, about 4500 in³ or about 5000 in³. Wall-flow filter substrates typically have a wall thickness from about 50 microns to about 2000 microns, for example from about 50 microns to about 450 microns or from about 150 microns to about 400 microns.

The walls of the wall-flow filter are porous and generally have a wall porosity of at least about 40% or at least about 50% with an average pore diameter of at least about 10 microns prior to disposition of the functional coating. For instance, the wall-flow filter article substrate in some embodiments will have a porosity of ≥40%, ≥50%, ≥60%, ≥65% or ≥70%. For instance, the wall-flow filter article substrate will have a wall porosity of from about 50%, about 60%, about 65% or about 70% to about 75% and an average pore diameter of from about 10, or about 20, to about 30, or about 40 microns prior to disposition of a catalytic coating. The terms “wall porosity” and “substrate porosity” mean the same thing and are interchangeable. Porosity is the ratio of void volume (or pore volume) divided by the total volume of a substrate material. Pore size and pore size distribution are typically determined by Hg porosimetry measurement.

### Substrate Coating Process

To produce SCR or SCRoF catalytic articles of the present disclosure, a substrate as described herein is contacted with an SCR or SCRoF catalyst as disclosed herein to provide a coating (i.e., the slurry comprising particles of the treated zeolite are disposed on a substrate). The coatings are “catalytic coating compositions” or “catalytic coatings.” A “catalyst composition” and a “catalytic coating composition” are synonymous.

The present SCR or SCRoF catalysts may typically be applied in the form of one or more washcoats containing the SCR or SCRoF catalyst as disclosed herein. A washcoat is formed by preparing a slurry containing a specified solids content (e.g., about 10 to about 60% by weight) of catalyst in a liquid vehicle, which is then applied to a substrate using any washcoat technique known in the art and dried and calcined to provide a coating layer. If multiple coatings are applied, the substrate is dried and /or calcined after each washcoat is applied and/or after the number of desired multiple washcoats are applied. In one or more embodiments, the catalytic material(s) are applied to the substrate as a washcoat.

In some embodiments, the drying is performed at a temperature of from about 100 to about 150° C. In some embodiments, drying is performed in a gas atmosphere. In some embodiments, the gas atmosphere comprises oxygen. In some embodiments, the drying is performed for a duration of time in the range of from 10 minutes to 4 hours, more preferably in the range of from 20 minutes to 3 hours, more preferably from 50 minutes to 2.5 hours.

In some embodiments, the calcination is performed at a temperature of from about 300 to 900° C., from about 400 to about 650° C., or from about 450 to about 600° C. In some embodiments, the calcination is performed in a gas atmosphere. In some embodiments, the gas atmosphere comprises oxygen. In some embodiments, the calcination is performed for a duration of time in the range of from 10 minutes to about 8 hours, from about 20 minutes to about 3 hours, or from about 30 minutes to about 2.5 hours.

After calcining, the catalyst loading obtained by the above described washcoat technique can be determined through calculation of the difference in coated and uncoated weights of the substrate. As will be apparent to those of skill in the art, the catalyst loading can be modified by altering the slurry rheology. In addition, the coating/drying/calcining process to generate a washcoat layer (coating layer) can be repeated as needed to build the coating to the desired loading level or thickness, meaning more than one washcoat may be applied. In some embodiments, the catalyst washcoat loading is in the range of from about 0.8 to 2.6 g/in³, from about 1.2 to 2.2 g/in³, or from about 1.5 to about 2.2 g/in³.

The present SCR or SCRoF catalytic coating may comprise one or more coating layers, where at least one layer comprises the present SCR or SCRoF catalyst. The catalytic coating may comprise one or more thin, adherent coating layers disposed on and in adherence to least a portion of a substrate. The entire coating comprises the individual “coating layers”.

### Coating Configurations

In some embodiments, the present SCR or SCRoF catalytic articles may include the use of one or more catalyst layers and combinations of one or more catalyst layers. Catalytic materials may be present on the inlet side of the substrate wall alone, the outlet side alone, both the inlet and outlet sides, or the wall itself may consist all, or in part, of the catalytic material. The catalytic coating may be on the substrate wall surfaces and/or in the pores of the substrate walls, that is “in” and/or “on” the substrate walls. Thus, the phrase “a washcoat disposed on the substrate” means on any surface, for example on a wall surface and/or on a pore surface.

The washcoat(s) can be applied such that different coating layers may be in direct contact with the substrate. Alternatively, one or more “undercoats” may be present, so that at least a portion of a catalytic coating layer or coating layers are not in direct contact with the substrate (but rather, are in contact with the undercoat). One or more “overcoats” may also be present, so that at least a portion of the coating layer or layers are not directly exposed to a gaseous stream or atmosphere (but rather, are in contact with the overcoat).

Alternatively, the present catalyst composition may be in a top coating layer over a bottom coating layer. The catalyst composition may be present in a top and a bottom layer. Any one layer may extend the entire axial length of the substrate, for instance a bottom layer may extend the entire axial length of the substrate and a top layer may also extend the entire axial length of the substrate over the bottom layer. Each of the top and bottom layers may extend from either the inlet or outlet end.

For example, both bottom and top coating layers may extend from the same substrate end where the top layer partially or completely overlays the bottom layer and where the bottom layer extends a partial or full length of the substrate and where the top layer extends a partial or full length of the substrate. Alternatively, a top layer may overlay a portion of a bottom layer. For example, a bottom layer may extend the entire length of the substrate and the top layer may extend about 10%, about 20%, about 30%, about 40%, about 50%, about 60%, about 70%, about 80% or about 90% of the substrate length, from either the inlet or outlet end.

Alternatively, a bottom layer may extend about 10%, about 15%, about 25%, about 30%, about 40%, about 45%, about 50%, about 55%, about 60%, about 65%, about 70%, about 75%, about 80%, about 85% or about 95% of the substrate length from either the inlet end or outlet end and a top layer may extend about 10%, about 15%, about 25%, about 30%, about 40%, about 45%, about 50%, about 55%, about 60%, about 65%, about 70%, about 75%, about 80%, about 85% or about 95% of the substrate length from either the inlet end of outlet end, wherein at least a portion of the top layer overlays the bottom layer. This “overlay” zone may for example extend from about 5% to about 80% of the substrate length, for example about 5%, about 10%, about 20%, about 30%, about 40%, about 50%, about 60% or about 70% of the substrate length.

In some embodiments, the SCR or SCRoF catalyst as disclosed herein, disposed on the substrate as disclosed herein, comprises a first washcoat disposed on at least a portion of the length of the catalyst substrate.

In some embodiments, the first washcoat is disposed directly on the catalyst substrate, and a second washcoat (either the same or comprising a different catalyst or catalyst component) is disposed on at least a portion of the first washcoat. In some embodiments, the second washcoat is disposed directly on the catalyst substrate, and the first washcoat is disposed on at least a portion of the second washcoat. In some embodiments, the first washcoat is disposed directly on the catalyst substrate from the inlet end to a length of from about 10% to about 50% of the overall length; and the second washcoat is disposed on at least a portion of the first washcoat. In some embodiments, the second washcoat is disposed directly on the catalyst substrate from the inlet end to a length of from about 50% to about 100% of the overall length; and the first washcoat is disposed on at least a portion of the second washcoat. In some embodiments, the first washcoat is disposed directly on the catalyst substrate from the inlet end to a length of from about 20% to about 40% of the overall length, and the second washcoat extends from the inlet end to the outlet end. In some embodiments, the first washcoat is disposed directly on the catalyst substrate from the outlet end to a length of from about 10% to about 50% of the overall length, and the second washcoat is disposed on at least a portion of the first washcoat. In some embodiments, the first washcoat is disposed directly on the catalyst substrate from the outlet end to a length from about 20 to about 40% of the overall length, and the second washcoat extends from the inlet end to the outlet end. In some embodiments, the second washcoat is disposed directly on the catalyst substrate from the outlet end to a length of from about 50% to about 100% of the overall length, and the first washcoat is disposed on at least a portion of the second washcoat. In some embodiments, the first washcoat is disposed directly on the catalyst substrate covering 100% of the overall length, and the second washcoat is disposed on the first washcoat covering 100% of the overall length. In some embodiments, the second washcoat is disposed directly on the catalyst substrate covering 100% of the overall length, and the first washcoat is disposed on the second washcoat covering 100% of the overall length.

The catalytic coating may advantageously be “zoned,” comprising zoned catalytic layers, that is, where the catalytic coating contains varying compositions across the axial length of the substrate. This may also be described as “laterally zoned”. For example, a layer may extend from the inlet end towards the outlet end extending about 10%, about 20%, about 30%, about 40%, about 50%, about 60%, about 70%, about 80%, or about 90% of the substrate length. Another layer may extend from the outlet end towards the inlet end extending about 10%, about 20%, about 30%, about 40%, about 50%, about 60%, about 70%, about 80%, or about 90% of the substrate length. Different coating layers may be adjacent to each other and not overlay each other. Alternatively, different layers may overlay a portion of each other, providing a third “middle” zone. The middle zone may, for example, extend from about 5% to about 80% of the substrate length, for example about 5%, about 10%, about 20%, about 30%, about 40%, about 50%, about 60% or about 70% of the substrate length.

Zones of the present disclosure are defined by the relationship of coating layers. With respect to different coating layers, there are a number of possible zoning configurations. For example, there may be an upstream zone and a downstream zone, there may be an upstream zone, a middle zone and a downstream zone, there may four different zones, etc. Where two layers are adjacent and do not overlap, there are upstream and downstream zones. Where two layers overlap to a certain degree, there are upstream, downstream and middle zones. Where for example, a coating layer extends the entire length of the substrate and a different coating layer extends from the outlet end a certain length and overlays a portion of the first coating layer, there are upstream and downstream zones.

For instance, the SCR or SCRoF article may comprise an upstream zone comprising the first washcoat layer; and a downstream zone comprising the second washcoat layer comprising a different catalyst material or component. Alternatively, an upstream zone may comprise the second washcoat layer and a downstream zone may comprise the first washcoat layer.

In some embodiments, the first washcoat is disposed on the catalyst substrate from the inlet end to a length of from about 10% to about 50% of the overall length; and the second washcoat is disposed on the catalyst substrate from the outlet end to a length of from about 50% to about 90% of the overall length. In some embodiments, the first washcoat is disposed on the catalyst substrate from the outlet end to a length of from about 10% to about 50% of the overall length; and wherein the second washcoat is disposed on the catalyst substrate from the inlet end to a length of from about 50% to about 90% of the overall length.

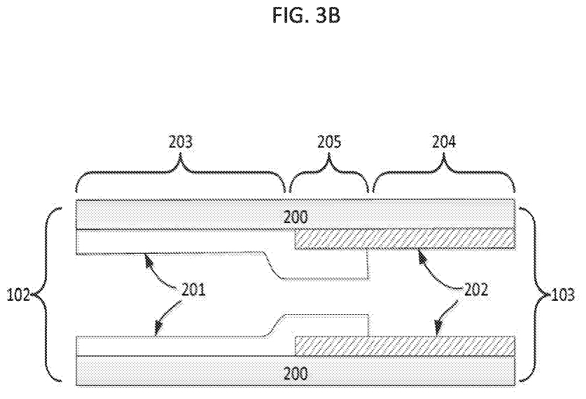

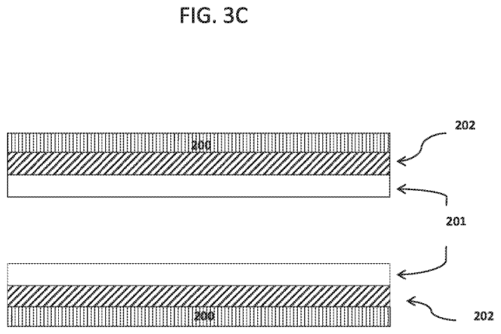

FIGS. 3a, 3b, and 3c show some possible coating layer configurations with two coating layers. Shown are substrate walls 200 onto which coating layers 201 (top coat) and 202 (bottom coat) are disposed. This is a simplified illustration, and in the case of a porous wall-flow substrate, not shown are pores and coatings in adherence to pore walls and not shown are plugged ends. In FIG. 3a, bottom coating layer 202 extends from the outlet about 50% of the substrate length and top coating layer 201 extends from the inlet greater than 50% of the length and overlays a portion of layer 202, providing an upstream zone 203, a middle overlay zone 205 and a downstream zone 204. In FIG. 3b, coating layers 201 and 202 each extend the entire length of the substrate with top layer 201 overlaying bottom layer 202. The substrate of FIG. 3b does not contain a zoned coating configuration. FIG. 3c is illustrative of a zoned configuration having a coating layer 202 which extends from the outlet about 50% of the substrate length to form a downstream zone 204, and a coating layer 201 which extends from the inlet about 50% of the substrate length, providing an upstream zone 203. FIGS. 3a, 3b, and 3c may be useful to illustrate SCR or SCRoF coatings on a wall-through substrate or the flow-through substrate.

In some embodiments is provided an SCR or SCRoF catalyst article comprising a substrate as disclosed herein and a treated zeolite as disclosed herein, disposed on at least a portion of the substrate. The substrate comprises an inlet end, an outlet end, an axial length extending from the inlet end to the outlet end, and a plurality of passages defined by internal walls of the substrate extending therethrough. Such SCR or SCRoF catalyst articles are obtained or obtainable by the process as disclosed herein. In some embodiments, the SCR or SCRoF catalyst article as disclosed herein exhibits improved NOₓ conversion. In some embodiments, the conversion of NOₓ to nitrogen at low temperature (<300° C.) is improved relative to an SCR or SCRoF catalyst article wherein the metal ion-exchanged zeolite is prepared by a conventional process, e.g., wherein the metal ion source is an acetate salt of copper.

### III. Exhaust Gas Treatment Systems

In a further aspect is provided an exhaust gas treatment system comprising a lean burn engine that produces an exhaust gas stream and the SCR or SCRoF article as disclosed herein. The engine can be, e.g., a diesel engine which operates at combustion conditions with air in excess of that required for stoichiometric combustion, i.e. lean conditions. In other embodiments, the engine can be an engine associated with a stationary source (e.g., electricity generators or pumping stations). In some embodiments, the emission treatment system further comprises one or more additional catalytic components. The relative placement of the various catalytic components present within the emission treatment system can vary.

In the present exhaust gas treatment systems and methods, the exhaust gas stream is received into the article(s) or treatment system by entering the upstream end and exiting the downstream end. The inlet end of a substrate or article is synonymous with the “upstream” end or “front” end. The outlet end is synonymous with the “downstream” end or “rear” end. The treatment system is, in general, downstream of and in fluid communication with an internal combustion engine.

The systems disclosed herein comprise a catalytic article as disclosed herein, and may further comprise one or more additional components. In some embodiments, the one or more additional components are selected from the group consisting of a diesel oxidation catalyst (DOC), a soot filter (which can be catalyzed or uncatalyzed), a selective catalytic reduction (SCR) catalyst, a urea injection component, an ammonia oxidation catalyst (AMOx), a low-temperature NOₓ absorber (LT-NA), a lean NOₓ trap (LNT), and combinations thereof. A system may contain, for instance, a selective catalytic reduction catalyst (SCR) as disclosed herein, a diesel oxidation catalyst (DOC) and one or more articles containing a reductant injector, a soot filter, an ammonia oxidation catalyst (AMOx) or a lean NOₓ trap (LNT). An article containing a reductant injector is a reduction article. A reduction system includes a reductant injector and/or a pump and/or a reservoir, etc. The present treatment system may further comprise a soot filter and/or an ammonia oxidation catalyst. A soot filter may be uncatalyzed or may be catalyzed (CSF). For instance, the present treatment system may comprise, from upstream to downstream, an article containing a DOC, a CSF, a urea injector, a SCR article and an article containing an AMOx. A lean NOₓ trap (LNT) may also be included.

The relative placement of the various catalytic components present within the emission treatment system can vary. In the present exhaust gas treatment systems and methods, the exhaust gas stream is received into the article(s) or treatment system by entering the upstream end and exiting the downstream end. The inlet end of a substrate or article is synonymous with the “upstream” end or “front” end. The outlet end is synonymous with the “downstream” end or “rear” end. The treatment system is, in general, downstream of and in fluid communication with an internal combustion engine.

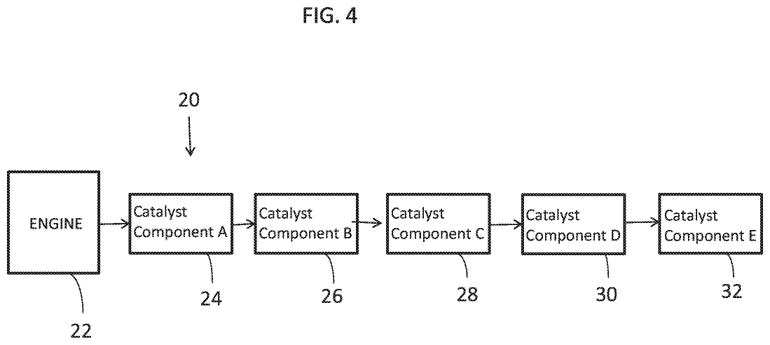

One exemplary emission treatment system is illustrated in FIG. 4, which depicts a schematic representation of an emission treatment system 20. As shown, the emission treatment system can include a plurality of catalyst components in series downstream of an engine 22, such as a lean burn gasoline engine. At least one of the catalyst components will be the SCR catalyst of the invention as set forth herein. The catalyst composition of the invention could be combined with numerous additional catalyst materials and could be placed at various positions in comparison to the additional catalyst materials. FIG. 4 illustrates five catalyst components, 24, 26, 28, 30, 32 in series; however, the total number of catalyst components can vary and five components is merely one example. One of skill in the art will recognize that it may be desirable to arrange the relative position of each article in a different order than illustrated herein; such alternative ordering is contemplated by the present disclosure.

Without limitation, Table 1 presents various exhaust gas treatment system configurations of one or more embodiments. It is noted that each catalyst is connected to the next catalyst via exhaust conduits such that the engine is upstream of catalyst A, which is upstream of catalyst B, which is upstream of catalyst C, which is upstream of catalyst D, which is upstream of catalyst E (when present). The reference to Components A-E in the table can be cross-referenced with the same designations in FIG. 4.

The LNT catalyst noted in Table 1 can be any catalyst conventionally used as a NOₓ trap, and typically comprises NOₓ-adsorber compositions that include base metal oxides (BaO, MgO, CeO₂, and the like) and a platinum group metal for catalytic NO oxidation and reduction (e.g., Pt and Rh).

The LT-NA catalyst noted in Table 1 can be any catalyst that can adsorb NOₓ (e.g., NO or NO₂) at low temperatures (<250° C.) and release it to the gas stream at high temperatures (>250° C.). The released NOₓ is generally converted to N₂ and H₂O over a down-stream SCR or SCRoF catalyst, such as disclosed herein. Typically, a LT-NA catalyst comprises Pd-promoted zeolites or Pd-promoted refractory metal oxides.

Reference to SCR in the table refers to an SCR catalyst, which may include the SCR catalyst composition of the invention. Reference to SCRoF (or SCR on filter) refers to a particulate or soot filter (e.g., a wall-flow filter), which can include the SCR catalyst composition of the invention. Where both SCR and SCRoF are present, one or both can include the SCR catalyst of the present disclosure, or one of the catalysts could include a conventional SCR catalyst (e.g., SCR catalyst prepared according to conventional ion exchange processes).

Reference to AMOx in the table refers to an ammonia oxidation catalyst, which can be provided downstream of the catalyst of one more embodiments of the invention to remove any slipped ammonia from the exhaust gas treatment system. In specific embodiments, the AMOx catalyst may comprise a PGM component. In one or more embodiments, the AMOx catalyst may comprise a bottom coat with PGM and a top coat with SCR functionality.

As recognized by one skilled in the art, in the configurations listed in Table 1, any one or more of components A, B, C, D, or E can be disposed on a particulate filter, such as a wall flow filter, or on a flow-through honeycomb substrate. In one or more embodiments, an engine exhaust system comprises one or more catalyst components mounted in a position near the engine (in a close-coupled position, CC), with additional catalyst components in a position underneath the vehicle body (in an underfloor position, UF). In one or more embodiments, the exhaust gas treatment system may further comprise a urea injection component.

TABLE 1
Possible exhaust gas treatment system configurations

| Compo- | Compo- | Compo- | Compo- | Compo- |
|---|---|---|---|---|
| nent A | nent B | nent C | nent D | nent E |
| DOC | SCR | Optional | — | — |
| | | AMOx | | |
| DOC | SCRoF | Optional | — | — |
| | | AMOx | | |
| DOC | SCRoF | SCR | Optional | — |
| | | | AMOx | |
| DOC | SCR | SCRoF | Optional | — |
| | | | AMOx | |
| DOC | SCR | SCRoF | CSF | Optional |
| | | | | AMOx |
| DOC | SCR | CSF | Optional | — |
| | | | AMOx | |
| DOC | CSF | SCR | Optional | — |
| | | | AMOx | |
| LNT | CSF | SCR | Optional | — |
| | | | AMOx | |
| LNT | SCRoF | SCR | Optional | — |
| | | | AMOx | |
| LT-NA | CSF | SCR | Optional | — |
| | | | AMOx | |
| LT-NA | SCRoF | SCR | Optional | — |
| | | | AMOx | |
| DOC | LNT | CSF | SCR | Optional |
| | | | | AMOx |
| DOC | LNT | SCRoF | SCR | Optional |
| | | | | AMOx |
| DOC | LT-NA | CSF | SCR | Optional |
| | | | | AMOx |
| DOC | LT-NA | SCRoF | SCR | Optional |
| | | | | AMOx |

### IV. Method of Treating an Engine Exhaust Gas Stream

Another aspect of the present disclosure is directed to a method of treating the exhaust gas stream of a lean burn engine, particularly a lean burn gasoline engine or diesel engine. Generally, the method comprises contacting the exhaust gas stream with the catalytic article of the present disclosure, or the emission treatment system of the present disclosure. The method can include placing the SCR or SCRoF catalyst article according to one or more embodiments of the invention downstream from an engine and flowing the engine exhaust gas stream over the catalyst. In one or more embodiments, the method further comprises placing additional catalyst components downstream from the engine as noted above. In some embodiments, the method comprises contacting the exhaust gas stream with the catalytic article or the exhaust gas treatment system of the present disclosure, for a time and at a temperature sufficient to reduce the levels of one or more NOₓ components which may be present in the exhaust gas stream.

The present catalyst compositions, articles, systems, and methods are suitable for treatment of exhaust gas streams of internal combustion engines, for example gasoline, light-duty diesel and heavy duty diesel engines. The catalyst compositions are also suitable for treatment of emissions from stationary industrial processes, removal of noxious or toxic substances from indoor air or for catalysis in chemical reaction processes.

It will be readily apparent to one of ordinary skill in the relevant arts that suitable modifications and adaptations to the compositions, methods, and applications described herein can be made without departing from the scope of any embodiments or aspects thereof. The compositions and methods provided are exemplary and are not intended to limit the scope of the claimed embodiments. All of the various embodiments, aspects, and options disclosed herein can be combined in all variations. The scope of the compositions, formulations, methods, and processes described herein include all actual or potential combinations of embodiments, aspects, options, examples, and preferences herein. All patents and publications cited herein are incorporated by reference herein for the specific teachings thereof as noted, unless other specific statements of incorporation are specifically provided

### EXAMPLES

Aspects of the present invention are more fully illustrated by the following examples, which are set forth to illustrate certain aspects of the present invention and are not to be construed as limiting thereof. Before describing several exemplary embodiments, it is to be understood that the invention is not limited to the details of construction or process steps set forth in the following description, and is capable of other embodiments and of being practiced or being carried out in various ways. Unless otherwise noted, all parts and percentages are by weight, and all weight percentages are expressed on a dry basis, meaning excluding water content, unless otherwise indicated.

### Preparation of Copper Ion Exchanged Zeolites

In-situ ion exchange (ISIE) was carried out using CHA zeolite pre-exchanged with 1.25% by weight of copper (measured on a CuO basis). The CHA had a silica to alumina ratio (SiO₂:Al₂O₃) of 25, a primary particle size of less than about 0.5 micrometer, and a BET specific surface area of about 600 m²/g. Various copper salts were used as the copper ion source, including copper oxide, copper oxide plus acetic acid, copper oxide plus zirconium acetate, copper acetate, copper nitrate, copper oxide plus nitric acid, copper hydroxide, and basic copper carbonate.

In each instance, the copper salt was dissolved or suspended in water in an amount to achieve a target loading of copper (as CuO) of 3.31% by weight. The resulting mixture was milled so that the D50 value of the particles was about 2.5 micrometers and the D90 value of the particles was about 5 micrometers. After this step, the CHA zeolite was added to the copper containing slurry and the resulting slurry thoroughly mixed. The resulting slurry was milled until the D90 value of the particles was about 4.5 micrometers. After completion of the ISIE process, the samples were calcined at 450° C. for 2 hours.

### Copper Exchange Efficiency

The copper exchange efficiency of the ISIE process was evaluated for the samples produced using the various copper salts. The exchange efficiency is defined as the ratio of exchanged copper over total copper, as determined by ammonia back exchange and inductively coupled plasma-optical emission spectrometry ICP-OES. The assay was performed after drying the slurry at 130° C. for 1 hr and calcining dried powder at 450° C. for 2 hr.

Copper ion exchanged zeolites prepared by ISIE using either CuO with or without acetic acid or nitric acid, copper acetate, copper nitrate, or basic copper carbonate all exhibited high levels of exchange efficiency (84.6 to 89.9%) as indicated in Table 1. Surprisingly, the copper ion exchanged zeolite prepared from basic copper carbonate exhibited a significantly higher percentage of ion exchanged copper as Cu²⁺ as measured by DRIFTs.

Diffuse reflectance infrared Fourier transform spectroscopy (DRIFTS) measurements were performed on a THERMO NICOLET instrument with a MCT (HgCdTe) detector and a Harrick environmental chamber with ZnSe windows. The copper ion exchanged zeolitic materials were ground to a fine powder with mortar and pestle and placed into the sample cup. The powder was dehydrated at 400° C. for 1 hour in flowing Ar at 40 mL/min and cooled to 30° C. and the spectra were recorded using KBr as a reference.

Copper species in zeolitic material can be identified by monitoring the perturbed T-O-T bond (Si—O—Al and Si—O—Si) vibrations by infrared (IR) spectroscopy. The structural vibrations of T-O-T bonds in zeolite have absorption peaks at 1300-1000 cm−1 and 850-750 cm−1 for asymmetric and symmetric vibration mode, respectively. The frequency of asymmetric T-O-T vibration of the oxygen ring is sensitive to the interaction with cations and therefore the IR band shifts from typical 1000-1300 cm−1 (position characteristic of unperturbed ring) to about 850-1000 cm−1 when interacting with a cation. The shifted band appears in the transmission window between two strong bands of T-O-T asymmetric and symmetric vibrations. The position of such a shifted band depends on the properties of the cations. Such perturbed T-O-T bond vibrations are observed when copper ions are exchanged into cationic position of zeolite framework structures, due to strong interaction between copper ions and neighboring oxygen atoms in the framework structure. The peak position depends on the status of compensated cations and the structure of the zeolite framework. The peak intensity depends on the quantity of compensated cations in the exchanged sites.

The peak fitting was carried out in Origin 9.1 software. In the peak fitting, the peaks were modeled as Gaussian peaks and peak fitting runs were performed until a chi-squared tolerance value of 1E-6 was reached. The IR signals at the wavelength range of 900-955 cm−1 due to perturbed T-O-T bond vibration absorption were attributed to the exchanged copper ions in the zeolitic material. The absorption peak having a maximum at the wavelength of 900 cm−1 was attributed to perturbed T-O-T bond vibration by Cu', the absorption peak having a maximum at the wavelength of 955 cm−1 was attributed to perturbed T-O-T bond vibration by Cu(OH)+. The peak position at the wavelength of 935 cm−1 was included to enable the peak deconvolution by software. The sum of the peak areas from 955 to 900 cm−1 is an indication of total exchanged copper ions in exchanged sites including CuOH⁺ and Cu²⁺.

TABLE 2
Copper ion exchange for various copper ion sources

| Metal Ion | % of Cu present as Ion | |
|---|---|---|
| Source | Exchanged Cu | Cu²⁺ Signal (DRIFTs) |
| CuO | 86.77 | 136.98 |
| CuO + HOAc | 86.1 | 153.3 |
| Cu(OAc)₂ | 84.62 | 124.98 |
| CuO + Zr(OAc)ₓ | 82.02 | 139.15 |
| CuO + HNO₃ | 85.05 | 118.82 |
| Cu(NO₃)₂ | 89.89 | 104.43 |
| Cu(OH)₂ | 83.48 | 132.11 |
| CuCO₃•Cu(OH)₂ | 85.54 | 185.9 |

### Catalyst Activity as Measured by TPR

Examples of copper ion exchanged zeolites prepared from various copper sources were evaluated by hydrogen TPR to determine the reactivity of the catalysts. Experimental conditions were as follows:

Pretreatment: He, 50 cc/min, 110° C. 1 h.

H₂-TPR: 5%H₂/N₂, 50 cc/min, 80° C.-900° C., 10° C./min.

The same amount of catalyst powders was used in TPR experiments. The first step was the pretreatment at 50 cc/min He at 110° C. for 1 hr to remove the loosely bonded adsorbents and clean the catalyst surface. The second step was to feed 50 cc/min gas mixture of H₂ in N₂ from 80° C. to 900° C. with a temperature ramping rate of 10° C./min. The resulting spectrum was recorded and used to determine the temperature and amount of H₂ consumption.

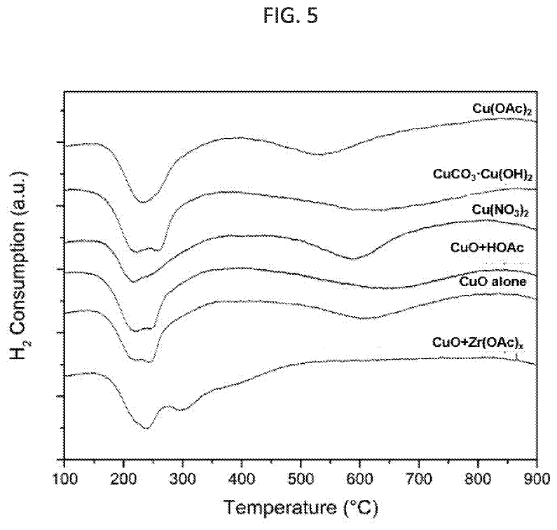

Results from the sample prepared according to embodiments of the presently disclosed method (using basic copper carbonate) as well as comparative examples produced from various copper sources, are provided in Table 3 and FIG. 5. The example prepared according to the presently disclosed method (using basic copper carbonate) exhibited a lower starting temperature (low-temperature peak, “LT”) for the first H₂-TPR peak, and a higher consumption of H₂ relative to the comparative examples. These results demonstrate that the copper ion-exchanged zeolite prepared according to the presently disclosed method was more reducible and therefore a more reactive catalyst.

TABLE 3
Hydrogen TPR for various copper ion sources

| | | LT | H₂-Consumption |
|---|---|---|---|
| | LT peak from | H₂-Consumption | from |
| Metal Ion | H₂-TPR | from | H₂-TPR <300° C. |
| Source | (° C.) | H₂-TPR (cm³/g) | (cm³/g) |
| CuO | 220 | 2.6 | 4 |
| CuO + HOAc | 226 | 2.8 | 3.9 |
| Cu(OAc)₂ | 235 | 3.5 | 3.6 |
| CuO + Zr(OAc)ₓ | 235 | 3.5 | 3.5 |
| Cu(NO₃)₂ | 213 | 1 | 2.8 |
| CuCO₃•Cu(OH)₂ | 226 | 4.1 | 4.4 |

### Preparation of Catalytic Articles

The previously prepared copper ion exchanged zeolites prepared from CuO-zirconium acetate (comparative) and basic copper carbonate (inventive) were mixed with an Al-based promoter (Al₂O₃, 94 weight %, with SiO₂, 6 weight %, and having a BET specific surface area of 173 m²/g, and a Dv90 of about 5 micrometers) to form a mixture having a solid content of 38 weight % based on the weight of said mixture. The amount of the copper ion exchanged zeolite was calculated such that the loading of zeolite after calcination was 87.8% of the loading of the coating in the catalyst after calcination. The resulting slurry was milled until the particles reached a Dv90 value of about 4.5 micrometers.

A porous uncoated wall-flow filter substrate (silicon carbide) was coated twice from the inlet end to the outlet end with the final slurry over 100% of the substrate axial length. To do so, the substrate was dipped in the final slurry from the inlet end until the slurry arrived at the top of the substrate. Further a pressure pulse was applied on the inlet end to distribute the slurry evenly in the substrate. The coated substrate was dried at 130° C. for 2 hours and calcined at 450° C. for 2 hours. This process was repeated once. The final coating loading after calcinations was 1.97 g/in³, including about 1.79 g/in³ of copper ion exchanged zeolite, 0.18 g/in³ of alumina+silica, and 3.63 weight % of Cu, calculated as CuO, based on the weight of the copper ion exchanged zeolite.

### Evaluation of Catalytic Articles-Engine Test

Comparative articles and inventive articles prepared according to embodiments of the present disclosure were evaluated in an engine test. The maximum NOₓ conversion achieved for the article prepared according to the disclosed method exhibited significantly higher NOₓ conversion below about 300° C., as compared to the article prepared with CuO-zirconium acetate as the copper ion source (Table 4). Performance evaluation was conducted under the following steady state conditions in the engine test cell:

(1) 192° C., 120 m³/hr and 140 ppm NOₓ, NO₂/NOₓ SCRoF inlet 4%;

(2) 221° C., 130 m³/hr and 190 ppm NOₓ, NO₂/NOₓ SCRoF inlet 4%;

(3) 283° C., 140 m³/hr and 420 ppm NOₓ, NO₂/NOₓ SCRoF inlet 11%;

(4) 595° C., 60 m³/hr and 180 ppm NOₓ, NO₂/NOₓ SCRoF inlet 13%; and

(5) 642° C., 110 m³/hr and 350 ppm NOₓ, NO₂/NOₓ SCRoF inlet 15%.

Values of temperature [° C.], volume flow [m³/h], NOₓ emissions [ppm] and NO₂/NOₓ ratio SCRoF inlet [%] were averaged over the dosing time.

TABLE 4
Maximum NOₓ conversion for embodiments of SCR catalyst articles

| | avg. temperature | Maximum NOx | | | | |
|---|---|---|---|---|---|---|
| | SCRoF | Conversion (%) | | | | |
| Metal Ion Source | inlet [° C.] | 192 | 221 | 283 | 595 | 642 |
| CuO + Zr(OAc)ₓ | Mean | 34 | 78 | 98 | 85.5 | 66 |
| CuO + Zr(OAc)ₓ | 1sigma | 1 | 2 | 0 | 0.5 | 0 |
| CuCO₃•Cu(OH)₂ | Mean | 54 | 86 | 99 | 77 | 54.5 |
| CuCO₃•Cu(OH)₂ | 1sigma | 2 | 1 | 0 | 1 | 0.5 |

The maximum NOₓ conversion achieved for the article prepared according to the disclosed method exhibited significantly higher NOₓ conversion at 192 and 221° C., as compared to the article prepared with CuO-zirconium acetate as the copper ion source, when limited to 20 ppm ammonia slip (Table 5).

TABLE 5
NOₓ conversion at 20 ppm ammonia slip for
embodiments of SCR catalyst articles

NOx Conversion @ 20 ppm NH₃ Slip [%]

| Metal Ion Source | | @192° C. | @221° C. |
|---|---|---|---|
| CuO + Zr(OAc)ₓ | Mean | 32.5 | 73.5 |
| CuO + Zr(OAc)ₓ | 1 sigma | 0.5 | 1.5 |
| CuCO₃•Cu(OH)₂ | Mean | 53 | 84.5 |
| CuCO₃•Cu(OH)₂ | 1 sigma | 2 | 0.5 |

The ammonia storage capacity for the article prepared according to the disclosed method was significantly higher at 221° C., as compared to the article prepared with CuO-zirconium acetate (which forms copper acetate in situ) as the copper ion source (Table 6).

TABLE 6
Ammonia storage capacity for embodiments
of SCR catalyst articles

NH₃ storage [g/l]

| Metal Ion Source | | @221° C. |
|---|---|---|
| CuO + Zr(OAc)ₓ | Mean | 0.46 |
| CuO + Zr(OAc)ₓ | 1 sigma | 0.02 |
| CuCO₃•Cu(OH)₂ | Mean | 0.615 |
| CuCO₃•Cu(OH)₂ | 1 sigma | 0.005 |

Together, the data presented in Tables 1-6 demonstrate that the presently disclosed process provides copper ion exchanged zeolites with a higher copper loading and increased ion-exchanged copper content, and articles comprising such copper ion exchanged zeolites exhibit enhanced low temperature conversion of NOₓ and ammonia storage capacity, relative to comparative examples.

1. A process for preparing a selective catalytic reduction (SCR) catalyst or a selective catalytic reduction on filter (SCRoF) catalyst, said SCR or SCRoF catalyst comprising a metal ion-exchanged zeolite, the process comprising:
(i) admixing a zeolite with an aqueous mixture comprising water and a metal ion source comprising a carbonate salt of copper, iron, or a mixture thereof, to form a slurry comprising a treated zeolite.

2. The process of claim 1, wherein admixing step further comprises adding a binder during the admixing step.

3. The process of claim 1, further comprising milling the aqueous mixture prior to performing the admixing step.

4. The process of claim 1, wherein the slurry comprises particles of the metal ion source having a D90 value of from about 0.5 to about 20 micrometers.

5. (canceled)

6. The process of claim 1, wherein the aqueous mixture further comprises one or more additives selected from a sugar, a dispersing agent, a surface tension reducer, a rheology modifier, and combinations thereof.

7. The process of claim 1, wherein the zeolite has a framework type selected from the group consisting of ABW, ACO, AEI, AEL, AEN, AET, AFG, AFI, AFN, AFO, AFR, AFS, AFT, AFX, AFY, AHT, ANA, APC, APD, AST, ASV, ATN, ATO, ATS, ATT, ATV, AVL, AWO, AWW, BCT, BEA, BEC, BIK, BOF, BOG, BOZ, BPH, BRE, BSV, CAN, CAS, CDO, CFI, CGF, CGS, CHA, CHI, CLO, CON, CZP, DAC, DDR, DFO, DPT, DOH, DON, EAB, EDI, EEI, EMT, EON, EPI, ERI, ESV, ETR, EUO, EZT, FAU, FER, FRA, GIS, GIU, GME, GON, GOO, HEU, IFR, IFY, IHW, IMF, IRN, ISV, ITE, ITG, ITH, ITW, IWR, IWS, IWV, IWW, JBW, JRY, JSR, JST, KFI, LAU, LEV, LIO, LIT, LOS, LOV, LTA, LTF, LTL, LTN, MAR, MAZ, MEI, MEL, MEP, MER, MFI, MFS, MON, MOR, MOZ, MRE, MSE, MSO, MTF, MTN, MTT, MVY, MTW, MWF, MWW, NAB, NAT, NES, NON, NPO, NPT, NSI, OBW, OFF, OKO, OSI, OSO, OWE, PAR, PAU, PCR, PHI, PON, PUN, RHO, RON, RRO, RSN, RTE, RTH, RUT, RWR, RWY, SAF, SAO, SAS, SAT, SAV, SBE, SBS, SBT, SCO, SEW, SFE, SFF, SFG, SFH, SFN, SFO, SFS, SFW, SGF, SGT, SIV, SOD, SOF, SOS, SSF, SSY, STF, STI, STO, STT, STW, SVR, SZR, TER, THO, TON, TSC, TUN, UEI, UFI, UOS, UOZ, USI, UTL, UWY, VET, VFI, VNI, VSV, WIE, WEN, YUG, ZON, and mixtures or intergrowths thereof.

8. (canceled)

9. (canceled)

10. The process of claim 1, wherein the zeolite has a framework consisting of Si, Al, and O, wherein the molar ratio of SiO₂:Al₂O₃ in the framework is from about 1 to about 100.

11. The process of claim 1, wherein the zeolite, prior to admixing with the aqueous mixture, comprises from about 0 wt % to about 1.25 wt % of copper, calculated as CuO based on the weight of the zeolite.

12. The process of claim 1, wherein the zeolite, prior to admixing with the aqueous mixture, comprises particles having a D50 value of from about 1 to about 5 micrometers, and a D90 value of from about 4 to about 10 micrometers.

13. The process of claim 1, wherein the zeolite has a BET specific surface area of from about 200 to about 1500 m²/g.

14. The process of claim 2, wherein the binder comprises an oxide of Al, Si, Ti, Zr, Ce, or a mixture of two or more thereof.

15. (canceled)

16. The process of claim 2, wherein the binder has a BET specific surface area of from about 200 to about 1000 m²/g,

17. The process of claim 2, wherein the binder has a D90 value of from about 0.5 to about 20 micrometers.

18. (canceled)

19. The process of claim 1, wherein the treated zeolite comprises particles having a D90 value of from about 0.5 to about 20 micrometers.

20. The process of claim 1, wherein the slurry has a solid content of from about 15 to about 45 wt %, based on the weight of said mixture.

21. The process of claim 1, wherein the amount of metal comprised in the treated zeolite is in the range of from about 2 to about 10 wt %, based on the weight of the metal ion-exchanged zeolite and calculated as the metal oxide.

22. The process of claim 1, wherein the metal ion source is basic copper carbonate or iron carbonate.

23. (canceled)

24. The process of claim 22, wherein the metal ion source further comprises one or more of copper oxide, copper hydroxide, copper nitrate, copper chloride, copper acetate, copper acetylacetonate, copper oxalate, or copper sulfate.

25. The process of claim 1, further comprising:
(ii) optionally, milling the slurry comprising the treated zeolite;
(iii) contacting a substrate with the slurry comprising the treated zeolite to form a coating on the substrate, the substrate comprising an inlet end, an outlet end, an axial length extending from the inlet end to the outlet end, and a plurality of passages defined by internal walls of the substrate extending therethrough;
(iv) drying the coated substrate;
(v) calcining the coated substrate obtained in (iv); and
(vi) optionally, repeating (iii) through (v) one or more times.

26. The process of claim 25, wherein the drying is performed at a temperature of from about 100 to about 150 ⁰0 and the calcining is performed at a temperature of from about 400 to about 600° C.

27. (canceled)

28. The process of claim 25, wherein the substrate is a flow-through or a wall-flow filter.

29. A treated zeolite, said treated zeolite being obtained or obtainable by a process according to claim 1.

30. The treated zeolite of claim 29, wherein the efficiency of metal ion exchange into the zeolite, defined as the ratio of exchanged metal ion to the total metal ion, as determined by combined ammonia back-exchange and inductively coupled plasma-optical emission spectrometry (ICP-OES), is greater than 80%.

31. The treated zeolite of claim 29, wherein a powder sample of the treated zeolite after 2 hours aging at 450° C., exhibits a higher H₂ consumption below 300° C. and a lower starting temperature of a 1s^{t} H₂-TPR peak relative to a treated zeolite prepared by a process wherein the metal ion source is an acetate salt of copper, iron, or a mixture thereof.

32. The treated zeolite of claim 29, wherein a powder sample of the treated zeolite is characterized as having a higher percentage of exchanged copper ions relative to a treated zeolite prepared by a process wherein the metal ion source is an acetate salt of copper, as determined by peak area of metal ion signals from T-O-T bonds in a diffuse reflectance infrared Fourier transform spectrogram.

33. An SCR or SCRoF catalyst article comprising a substrate and a treated zeolite disposed on at least a portion thereof, the substrate comprising an inlet end, an outlet end, an axial length extending from the inlet end to the outlet end, and a plurality of passages defined by internal walls of the substrate extending therethrough, said SCR or SCRoF catalyst article being obtained or obtainable by a process according to claim 25.

34. The SCR or SCRoF catalyst article of claim 33, wherein the conversion of NO, to nitrogen at temperatures lower than about 300° C. is improved relative to an SCR or SCRoF catalyst article wherein the treated zeolite is prepared by a process wherein the metal ion source is an acetate salt of copper.
